(19) United States
(12) Patent Application Publication
(10) Pub. No.: US 2011/0137489 A1
(43) Pub. Date: Jun. 9, 2011

(54) ASSET MONITORING SYSTEM

(76) Inventors: David S. Gilleland, Charlotte, NC (US); Rob Satchwell Tennant, Matthews, NC (US); Michael Layton Gregory, Clover, SC (US); Pieter Erasmus, Boksburg (ZA)

(21) Appl. No.: 12/889,646

(22) Filed: Sep. 24, 2010

Related U.S. Application Data
(63) Continuation-in-part of application No. PCT/US2009/005463, filed on Oct. 5, 2009.
(60) Provisional application No. 61/245,500, filed on Sep. 24, 2009.
(60) Provisional application No. 61/257,313, filed on Nov. 2, 2009.

(30) Foreign Application Priority Data
Aug. 4, 2010 (GB) 1013127.4
Aug. 4, 2010 (GB) 1013128.2
Aug. 4, 2010 (GB) 1013129.0
Aug. 4, 2010 (GB) 1013130.8
Aug. 4, 2010 (GB) 1013131.6

(51) Int. Cl. G06F 7/00

(52) U.S. Cl. 701/2; 701/33

(57) ABSTRACT

A vehicle asset monitoring system comprising a plurality of vehicle assets for lifting and carrying loads and a remote monitoring station for monitoring the vehicle assets. The vehicle assets each comprise a motive unit for generating a motive force to move the vehicle asset and a lift unit for generating a force to lift a load. A measurement interface is provided in each vehicle asset that is adapted to obtain a plurality of operational parameters including operational parameters representing a load lifted by the vehicle asset and another operational parameter related to usage of the vehicle asset. The remote monitoring station comprises a processor for analysing the operational parameters, and for initiating an action based on the analysis.

### CROSS REFERENCES TO RELATED APPLICATIONS

This application is a continuation-in-part of International Application No. PCT/US2009/005463, filed Oct. 5, 2009, which claims the benefit of U.S. Provisional Application No. 61/245,500, filed Sep. 24, 2009, the entire disclosures of which are hereby incorporated by reference. This application also claims the benefit of U.S. Provisional Application No. 61/257,313, filed Nov. 2, 2009, the entire disclosure of which is hereby incorporated by reference.

This application also claims the benefit of the following applications: GB Application No. 1013129.0, filed Aug. 4, 2010, GB Application No. 1013128.2, filed Aug. 4, 2010, GB Application No. 1013127.4, filed Aug. 4, 2010, GB Application No. 1013130.8, filed Aug. 4, 2010, and GB Application No. 1013131.6, filed Aug. 4, 2010, the entire disclosures of which are hereby incorporated by reference.

### BACKGROUND OF THE INVENTION

The present invention relates to an asset monitoring system, a monitoring and reporting device for an asset monitoring system, a monitoring station for the asset monitoring system, and associated methods, and in particular a vehicle asset monitoring system suitable for fleet vehicles.

It is well known to provide vehicles with individual keys to enable use of the vehicle. A problem for operators of fleets of vehicles is that keys need to be managed. A particular issue exists in the case of sites where there are multiple vehicles and multiple drivers who may use them. A particular problem occurs in the case of a fleet involving multiple vehicles which may have different training requirements.

### DESCRIPTION OF RELATED ART

Various solutions have been proposed providing electronic tokens which enable drivers to operate multiple vehicles. However in practice, each solution has its drawbacks. Some solutions implicitly tolerate over-authorisation and rely on drivers or manual processes in addition. Other solutions require complex logic, storage and processing capability on individual vehicles and/or necessitate real-time communication with a central controller to authorise drivers. Such systems can add to power requirement and weight, which may be significant in the context of a warehouse lift truck and add appreciably to both cost and carbon footprint of the apparatus and/or may not function reliably in environments where communication is problematic. Some systems may even require entire warehouses to be provided with dedicated radio communication infrastructure in order to function, which is costly and hinders deployment.

Pursuant to the invention it has been appreciated that it is desirable, particularly to deal with the problems typically encountered by lift trucks of a relatively harsh and unpredictable environment where reliable communication cannot be assured, to have a simple and robust solution which does not require complex costly delicate or power-hungry equipment on each vehicle.

Prior art maintenance systems rely upon periodically scheduled maintenance actions or ad-hoc maintenance based on need, for example a vehicle failure. In some cases maintenance requires resources such as particular spare parts or particular technical personnel. Resources may be present in a warehouse or other location.

It is known to perform location measurement for mobile assets such as vehicles using GPS systems or cellular network mast triangulation (cell triangulation). In storage facilities and industrial complexes the communications environment does not always favour such methods, for example GPS satellite signals may obscured by structures between the GPS receiver and the satellite. Similarly, where triangulation methods are employed if one of the signals employed is obscured the accuracy of the technique may degrade substantially, in addition problems such as signal multipath can provide anomalous or inaccurate triangulation results.

It is also known to monitor vehicle usage based on, for example, odometer data and to generate maintenance recommendations based on predetermined service intervals, or the like. However, such maintenance recommendations are often unreliable with vehicles either failing, potentially catastrophically, before service intervals expire or being serviced unnecessarily thereby increasing the cost of ownership.

### SUMMARY

Aspects and examples of the invention provide methods and systems and apparatus which address at least some of the above described problems. Aspects and examples of the invention are set out in the claims.

According to one aspect, the invention provides a remote monitoring station capable of monitoring at least one vehicle asset, the remote monitoring station comprising: a communication interface adapted to receive operational parameters from at least one vehicle asset, the operational parameters including: at least one operational parameter affected by a load lifted by the at least one vehicle asset; and at least one other operational parameter related to usage of the at least one vehicle asset; and a processor adapted to analyse said received operational parameters, and to initiate an action based on said analysis.

According to another aspect of the invention there is provided a method of monitoring at least one vehicle asset, the method comprising: receiving operational parameters from at least one vehicle asset, the operational parameters including: at least one operational parameter affected by a load lifted by the at least one vehicle asset; and at least one other operational parameter related to usage of the at least one vehicle asset; analysing said received operational parameters, and initiating an action based on said analysis.

The use of a load based parameter, in addition to other usage parameters, is particularly beneficial as an indicator of actual work undertaken by a vehicle asset and has been found to provide for greater accuracy and reliability when making maintenance predictions/recommendations, and predictions of future ownership/maintenance costs.

According to another aspect, the invention provides an authorisation control device for one of a plurality of fleet vehicles, the authorisation control device for selectively enabling operation of a vehicle on which it is installed comprising vehicle identity logic for storing or reading a vehicle identifier for the vehicle on which the authorisation control device is installed and a communication interface for communicating with a removable rewritable driver token storing a unique driver identifier and a list of a plurality of authorised vehicle identifiers denoting vehicles which the driver is authorised to drive, the authorisation control device including driver record logic for storing or communicating the unique driver identifier and enable logic for generating an enable signal for the vehicle based on matching the vehicle identifier for the vehicle on which the authorisation control device is installed with one of the vehicle identifiers in the list of authorised vehicles stored in the token.

In this way, the authorisation device is able to obtain and record a unique driver identifier or pass it on to other systems for use for example in identifying an individual driver in the event of an incident. However, it does not require complex logic to determine whether the driver is authorised; instead it simply needs to match its own vehicle identifier with the list of vehicle identifiers stored on the driver token. In a departure from prior art teachings, although a unique driver identifier is available, authorisation preferably does not require the driver to be looked up.

The invention further provides a driver access token, a system for updating driver access tokens and software and control systems and respective methods. Preferred features of each aspect may be applied to other aspects, as will be apparent.

According to a another aspect, the invention provides an authorisation control device for one of a plurality of fleet vehicles, the authorisation control device for selectively enabling operation of a vehicle on which it is installed comprising a communication interface for communicating with a removable rewritable token storing a unique holder identifier and information identifying a specified group of vehicles the holder is authorised to operate, the authorisation control device comprising enable logic for generating an enable signal for the vehicle in dependence on the information identifying the specified group of vehicles stored on the token.

In another aspect, the invention provides a removable rewritable access token having means for communicating with a vehicle authorisation device, the token storing a unique holder identifier, and information indicating the holder's authority to access each vehicle in a specified group (which may be the group comprising all vehicles).

The specified group may be the group of all vehicles of a specific type and/or having a specific specification, may be the group of all vehicles of a specific facility or in a particular geographic region, or ay be any other appropriate grouping including a group comprising a single vehicle.

The token may be a driver, maintenance or supervisor token. The information indicating the holder's authority to access all vehicles in a specified group may comprise a list of a plurality of authorised vehicle identifiers denoting vehicles which the holder is authorised to access and/or drive. The information indicating the holder's authority to access all vehicles in a specified group may comprise an indicator that the holder is a technician and/or supervisor.

The specified group may be the group of all vehicles of a specific type and/or having a specific specification, may be the group of all vehicles of a specific facility or in a particular geographic region, or may be any other appropriate grouping.

In another aspect, the invention provides a removable rewritable driver token having means for communicating with a vehicle authorisation device, the token storing a unique driver identifier and a list of a plurality of authorised vehicle identifiers denoting vehicles which the driver is authorised to drive.

Preferably the authorisation device is capable of communicating with a token capable of storing at least 20 vehicle IDs in addition to a driver ID, more preferably at least 100 vehicle IDs, still more preferably at least 500 vehicles. Preferably the authorisation device is capable of communicating with a token storing at least 1 kilobyte of data.

Preferably the driver ID and vehicle IDs are globally unique, preferably at least 32 bits each. Although an individual token may only store a smaller number of IDs in a given application, having such capacity enables a generic system to be employed with global tokens for multi-site applications without requiring grouping by site.

In a preferred embodiment, the authorisation device is arranged to communicate with the token wirelessly, preferably by means of an RFID-type protocol. Preferably the authorisation key is arranged to communicate at a data transfer rate of at least 5 kilobit/s, more preferably at least 10 kilobit/s. Preferably the authorisation device is arranged to supply power inductively for sustained communication.

In one embodiment, the authorisation device is arranged to download the list of authorised vehicle IDs and to check for a match after downloading the list. In a variant, the device is arranged to download IDs until a match is found but to discontinue downloading after a match is found. In an alternative embodiment, the token is a smart token and the authorisation device is arranged to query the token to see if the vehicle ID is stored and to receive a response indicating a match or not.

It is found that a storage capacity of between 1 kilobyte and 16 kilobytes provides sufficient storage capacity for a globally unique driver id, a list of vehicle authorisations and provide storage capacity for other driver specific data.

Optionally the token is arranged to store additional driver data not required to be downloaded for vehicle authorisation. The token may also serve as an ID card with visible text and/or a photo ID on the exterior. The token may store data for use by an application other than vehicle authorisation, for example a time and attendance application and/or security access to a building.

In one embodiment, an access point is provided separately from the vehicle or vehicles to be authorised to which a driver may present a token, for example on “clocking on” for work, the access point including reader circuitry for reading the token to recognise a unique identifier of the token and writing logic for updating the list of authorised vehicles stored on the token. In this way, authorisation can be managed transparently to the driver, without requiring individual vehicles to be updated, by updating the driver's card when it is presented. Updates may be processed at separate times and simply updated at next presenting of the token.

In one method, the access point is arranged to communicate with the token to instruct deletion or addition of individual entries. This can reduce update time. In other embodiments, the token can be updated by over-writing the authorised vehicle list with a new list. This simplifies the logic required on the token.

A further aspect provides a method of controlling access to a set of assets by an operator comprising: reading a machine-readable re-writable token storing a unique identifier of the operator and a list of assets for which the operator is authorised to obtain the unique operator identifier; checking whether updates for the set of assets for which the operator is authorised are stored; in the event that updates are stored, writing to the token to update the stored list of authorised assets.

The method preferably includes signalling that the token may be removed after writing is completed. This may be by means of an audible signal such as a beep and/or a visual signal such as a light. Alternatively, the token may be captured during writing and released after writing. In one preferred arrangement, communication with the token for both reading and writing is conducted wirelessly, preferably with a range of at least 5 cm, preferably at least 10 cm. In embodiments, communication is preferably conducted at a data transfer rate such that updating is completed in less than 5 seconds, preferably less than 2 seconds; in this way the token may not need to be captured. The method may include signalling an error, for example with an audible tone in the event that updating is not completed before the token is removed.

The access point may in one arrangement store updated lists for writing to specific tokens. Updates may be managed remotely, optionally by a central user console or consoles arranged to communicate remotely with the access points and preferably coupled to a database of operator authorisations. Updates may be transmitted to one or more access points. In some arrangements, one or more access points associated with an individual operator may be identified and updates sent only or preferentially to that or those access points. This has the benefit that a central authorising user may control access to multiple assets for a number of operators across multiple sites without requiring large real-time communication bandwidth as updates are simply sent to the relevant access point when entered in the database and uploaded at next token presentation, e.g. clocking on or off and is highly scalable to enterprise scale operations. Alternatively, an access point may query one or more remote databases for latest updates when a token is presented; this reduces storage and logic requirements at the access points. An access point can be arranged to communicate with the token to instruct over-writing the authorised vehicle list with a new list.

In a preferred arrangement, the method includes communicating the unique operator identifier to another application (for example an attendance or security application). In this way, when a token is presented for a particular purpose, access rights are seamlessly updated, without requiring a dedicated trip to an update terminal.

In an aspect of the invention there is provided a method of scheduling maintenance of a plurality of assets at a respective asset location, from a remote monitoring system, the method comprising receiving operational parameters from the plurality of assets at the remote monitoring system, wherein the operational parameters comprise an asset identifier and position information; and determining a likely maintenance action based on the operational parameters; and scheduling a maintenance action for one of the plurality of assets based on operational parameters associated with at least one other asset of the plurality of assets.

The operational parameters may also include parameters representing condition related information, usage information (e.g. load lifted, distance moved, hour usage, speeds reached), impact information (e.g. tilt, acceleration).

For example a likely maintenance action can include actual repair of an asset or preventive maintenance, for example to prevent a predicted component failure. Preferably a measure of asset location (and/or technical status) is derived from the operational parameters, this can be performed by inferring location information from the communication link (e.g. using the senders IP address, GSM mobile number or other communication identifier such as email address) and making a comparison with stored location information associated with that communication link. This may be implemented by storing communication link and location information in a database. Alternatively location information can be derived from an asset identifier of the operational parameters, for example a database may store an association between asset identifiers and locations. In one possibility received information comprises actual location information such as a street address, a map grid reference, location name i.e. a site identifier recognisable by a human operator (such as an abbreviated name, company code, or colloquial name for a location), or GPS co-ordinates, cell phone tower triangulation or any other location information.

Where an asset is a mobile asset, such as a warehouse vehicle or a forklift truck or reach truck communication may take place wirelessly between one or more of the plurality of assets and the remote monitoring station, alternatively wireless communication may be relayed to the remote monitoring system between one or more intermediate communications devices such as a router, wireless hub, GSM or GPRS modem or other communication device. Therefore receiving operational parameters from the plurality of assets at the remote monitoring system may comprise one or more intermediate communication steps, or may be direct.

Typically, where location information is to be inferred based on a vehicle identifier there is a need to update stored location information and/or associations between vehicle/asset identifiers and location information. Either periodically, intermittently or in response to an operator action a vehicle identifier is communicated by the vehicle for to a remote monitoring system updating a stored association between asset identifiers and locations. Alternatively when an asset/vehicle communicates with a remote monitoring system (or an intermediate hub or installation) the asset/vehicle identifier information is compared with a stored list of identifiers associated with that location and, in the event that it is determined that that vehicle identifier is associated with another location, the stored association is updated. Preferably, by this method, inventories of assets vehicles are updated without the need for manual surveys of which assets/vehicles are present in which locations.

Operational parameters can be used to indicate that an asset, such as a vehicle, requires repair and continuing to operate the vehicle without repair is associated with a reduced energy efficiency. If the energy cost associated with the maintenance action is less than the energy lost to inefficiency then the maintenance action is scheduled, for example to take place immediately, at the time of the next periodic maintenance visit or as soon as practicable.

Particular examples of the invention communicate CAN information to enable the lifetime or maintenance requirements of vehicle components to be predicted. In an example a facility monitoring system is arranged to collate predicted maintenance tasks for each of a plurality of vehicles to determine which vehicles will/may need to be serviced and when such action is most probable. Probability of a required maintenance action for each vehicle can be estimated based on CAN information and/or event information.

In another aspect there is provided a monitoring and reporting device for use in a mobile asset comprising: a measurement interface for measuring operational parameters of a mobile asset and a buffer coupled to the measurement interface for storing measured operational parameters; and a communication interface for receiving commands from a remote monitoring system and a processor configured to store measured operational parameters in the buffer in response to a received command.

The use of buffering is advantageous because it allows the operational parameters to be temporarily stored and communicated in ‘batches’. This ‘batch’ type communication has many benefits over realtime communication. In particular, in the harsh communications environment typically associated with locations where mobile assets such as lift trucks are used, communication is not always universally available in all areas to which the vehicles move. Accordingly, the use of a buffer allows the operational parameters to be stored until communication capability is restored, or until a particular reporting interval has been reached (or exceeded). Furthermore, batch communication has the potential to reduce energy usage of a communication device because it has the potential to reduce or eliminate failed communication attempts.

Typically the measurement interface includes a CANBUS interface and, for example, operational parameters include parameters derived from a CANBUS message wherein the processor is configurable by a remote command to store selected CANBUS messages for storage. Optionally CANBUS messages are selected based on a message type identifier and, in some examples the processor is configured to transmit the contents of the buffer using the communication interface before the buffer is full. Preferably, the monitoring and reporting device monitors communication availability and transmits some or all the contents of the buffer as soon as communications become available. The monitoring and reporting device may also keep track of one or more preferred periodic communication intervals (e.g. by means of at least one internal timer/clock) and transmit some or all the contents of the buffer whenever the interval has been reached (or exceeded by virtue of a lack of communication availability).

Where, for example, the information is assessed over a relatively long period of time (such as statistical information) it may advantageously be sent in batches at appropriate periodic intervals. Other information, which has the potential to indicate a requirement for more immediate action (such as, for example, information which may indicate a impending fault, or unauthorised vehicle usage) may always be sent as soon as communications is found to be available.

To operate in environments where communication is difficult and/or intermittently available the processor can be configured to determine whether the communication interface is able to communicate with a remote monitoring station. For improved reliability the processor can be configured to store data from the buffer into a non-volatile memory in the event that it is determined that the communication interface is not able to communicate with a remote monitoring station. To ensure timely reporting of data in a hostile communication environment the processor can be configured to test periodically, or at intervals, whether the communication interface is able to communicate with a remote monitoring station. In some examples, to save power the processor is coupled to a user actuable switch and is configured to test whether the communication interface is able to communicate with a remote monitoring station in response to actuation of the switch.

In certain environments there are known “sweet spots” for communication where a wireless communication link is generally reliable. Therefore a location determiner can be coupled to the processor and so that the processor can be configured to test whether the communication interface is able to communicate with a remote monitoring station in response to the location determiner indicating that the device is in a selected location. A location determiner may include a position monitoring system as described elsewhere herein. It will be appreciated, however, that in general, flushing the buffer as soon as a signal is detected (without testing based on location information) has the advantage of simplicity over this alternative location based method.

In one example a software application is provided to correlate probability of required maintenance across each of a plurality of vehicles within a fleet and, for example, across a plurality of such fleets held at separate locations to determine a schedule of maintenance actions based on one or more criteria. Criteria may include optimising an energy cost, optimising the energy cost of maintenance, optimising the financial cost of maintenance, ensuring sufficient vehicles/assets to meet operational need remain in working order. In other words, if the volume of work through a warehouse is low one or more assets may remain unrepaired without adversely affecting operation of the warehouse. In other circumstances all vehicles must be maintained at all times or additional vehicles may be required.

Where maintenance actions are required for a vehicle, typically there will be some inefficiency in operation of that vehicle which will increase over time, and, in a fleet of vehicles this effective is cumulative. Therefore, in one possibility scheduling a maintenance action for one of the plurality of assets based on the aggregated performance information comprises determining the energy cost of the maintenance action and determining the energy saving associated with the maintenance action and postponing the scheduled maintenance action if the overall energy cost associated with the maintenance action is less than the energy cost of vehicle inefficiency. When the cumulative loss of energy due to cumulative inefficiency of the vehicle fleet is greater than or equal to the energy cost of maintenance actions those actions should be performed. Advantageously this method minimises the energy cost of maintaining a fleet of vehicles.

Such methods enable the energy required to maintain a plurality of assets at a location remote from a maintenance facility to be minimised or at least optimised.

Method embodiments account for the reduced efficiency of running a vehicle in need of maintenance and taken into account the energy cost associated with repeated maintenance visits to a site. In preferred aspects and examples of the invention improved safety of operation is provided by maintenance based upon vehicle monitoring.

Preferred examples of this method comprise predicting a maintenance action based on one or more performance indicators associated with an asset. Performance indicators may include CAN information, performance information, usage information, diagnostic information, fault code occurrence, fault code frequency and/or other such information. The above described advantages can be further increased by scheduling maintenance actions based on a predicted maintenance action. For example if it is known that a maintenance action is imminent it can be attended to during regular scheduled maintenance associated with other vehicles and/or assets or it can be attended to at the same time as other ad-hoc or periodic maintenance visits thus reducing the carbon footprint of maintenance activities.

In an example a second plurality of assets are provided at a second asset location wherein the first and second locations are associated with a respective one of a first and second location indicator such that each maintenance action is associated with a location indicator. In some examples a plurality of such asset locations are provided each associated with a corresponding location indicator. Advantageously embodiments having more than one asset location provide further aggregate reductions in energy consumption (compared with such separate facilities maintained according to prior art methods) by permitting a travelling salesman optimisation which optimises a maintenance energy cost function dependent on required actions, the location associated with each action, and resources locations and priority

Particular resources at a second resource location may be obtained during other maintenance journeys for predicted maintenance or based on resource indicators such as the availability of the required spare parts and technicians having the required skills. In addition to the constraints of operational need and energy cost outlined above the availability of spare parts may alter the maintenance schedule. Therefore, in a preferred embodiment scheduling maintenance actions for one of the plurality of assets based on operational parameters associated with at least one other asset of the plurality of assets comprises scheduling based on at least one of: a spare parts inventory, an energy cost, operational need and/or usage requirements; and availability of a skilled technician.

As will be appreciated (and as is described below with reference to critical and non critical performance indicators) different maintenance actions are of differing priority.

Preferably therefore it is possible to assign priority to maintenance actions, and schedule maintenance actions based on priority and location. Maintenance requests which originate from the same, associated, or simply geographically nearby locations can be grouped and alternatively maintenance requests can be grouped by resource indicator and location.

In an example CAN information is downloaded to a remote monitoring facility in advance of scheduled maintenance, in response to a trigger or to determine a maintenance need based on a prediction or indicative information derived from monitoring information. In one example diagnostic data for a first vehicle can be downloaded in advance of scheduled maintenance of a second vehicle, or in response to a trigger generated by a second vehicle, for example need based on a prediction or indicative information derived from monitoring information of the second vehicle. Advantageously this permits maintenance actions for the first vehicle to be determined in response to another maintenance need. This can provide improved efficiency, help to diagnose problems before they occur and reduce the number of maintenance visits (and hence energy consumption) that would otherwise be required. In one example the CAN information selected to be downloaded is based on performance score for components (or an overall performance score) as described in greater detail below. The trigger for downloading information from a vehicle CAN may be the occurrence of a fault in another vehicle, optionally CAN download from a first vehicle is modified in response to CAN information from a second vehicle

In an aspect of the invention there is provided a programmable vehicle power controller comprising a wireless communication interface, and a vehicle inactivity detector for detecting inactivity affecting a component of a vehicle and a shutdown controller coupled to shut down at least a component of the vehicle and arranged to receive over the wireless communication interface a command to set an inactivity time interval based on the received command and to shut down the component following inactivity for the time interval. Optionally the shut down controller is also operable to shut down the vehicle in response to a received shut down command.

Preferably a vehicle inactivity detector is coupled to a vehicle CANBUS to detect that a vehicle's engine is or has been idling (for example, running without moving the vehicle, or with load lifting being detected). In some examples this function can be provided by an authorisation and control unit as described elsewhere herein. In these and related examples the vehicle power controller may be partly or wholly integrated with the authorisation control unit, in some possibilities it is provided as a separate unit or integrated with functionality of the vehicle.

In one embodiment the vehicle power controller is operable to set the time interval based on the received command and vehicle operator information which may be derived from an authorisation control unit. Alternatively vehicle operator information is derived from a removable reprogrammable token or a received command.

Typically a vehicle operator is associated with certain time schedule information, for example a shift pattern. As such vehicle operator information may include operator shift pattern information or operator shift pattern information can be provided separately, for example sent as a broadcast or as multiple unicast messages message one for each operator or one for all operators.

Clearly, time schedule information need not be dependent on a particular operator and the vehicle power controller may set the time interval based on time of day. Preferably the timer is operable to measure time of day and, for example, a received command may provide configuration information to configure the time interval in dependence upon the time of day. In one possibility the dependence on time of day may be modified by vehicle operator information or facility work volume information and/or vehicle location information.

A vehicle power controller can be coupled to the CANBUS and is operable to set the time interval based on CANBUS messages. As an example a vehicle power controller can couple to the CANBUS to listen for messages to a particular vehicle device (for example messages having a particular type identifier) and to set the time interval in dependence upon a message sent to (or by) one or more other vehicle devices. For example the vehicle power controller can be configured to modify the time interval in response to received messages from the CANBUS having a first message type identifier, alternatively it can be configured to receive messages from the CANBUS having first and second message type identifiers and to modify the time interval in response to messages of the first type depending upon the messages of the second type.

In other words, if for example the vehicle fuel is below a threshold level the time interval may be reduced to conserve fuel or if battery power is low but fuel is not the idle time may be extended to permit the battery to be recharged by the engine during idling. Alternative examples will be apparent to the skilled practitioner.

As will be appreciated the efficiency gain associated with switching off and restarting an engine may be diminished or negated by the efficiency cost associated with stopping and restarting the engine. Therefore the timeout period can be selected adaptively based on operator information, usage requirements (for example how many vehicles are operating in the facility at that time) time of day (relative to shift patterns) and/or the location of the vehicle. For example if the vehicle is in an aisle of a warehouse or in an area where usage requirements dictate frequent stopping and starting of the vehicle the switch-off time interval may be lengthened, alternatively if a vehicle is in a parking or waiting area a shorter permitted idle periods may be set.

In an aspect there is provided a server for communicating with a plurality of vehicles, each vehicle associated with a vehicle identifier, having a processor coupled to a memory comprising instructions for determining inactivity timeouts based on at least one of: time of day, workload, historical data, location, and operator input; and to communicate determined time outs to selected vehicles.

In an example, a packet based protocol is provided to write permitted idle times to a device, packets can be stored at a communication hub until communication with a destination vehicle becomes available so that there is no requirement for real time instant communication.

In one example a facility control system has an interface to a workflow system (to be provided with information about workflow requests). A control processor provides a time interval which is dependent on a programmable function of location information, workflow information and operator information. In other possibilities the time interval may be made dependent on work volume in facility or on the number of trucks working on floor/in a particular area of the facility. Location information may be derived from a warehouse positioning system as described herein (such as an RFID grid system).

Preferably operator information can be correlated with shift pattern information to update a time interval, alternatively or additionally time interval update information can be transmitted at particular times of day.

In one aspect there is provided a location monitoring system comprising a plurality of radio frequency transponders and a mobile radio frequency transceiver operable to receive a unique identifier from each of the plurality of RFID tags; and a memory storing an association between each of a plurality of unique identifiers and each of a plurality of location identifiers; and a controller arranged to compare an identifier read from one of the plurality of RFID tags with the stored associations to determine a location.

In one example the mobile radio frequency transceiver is attached to a mobile asset such as a forklift truck and typically the radio frequency transponders are passive RFID tags and the mobile radio frequency transceiver is an RFID reader. This provides a system which does not require wiring, or multiple power supplies or wireless communication with the truck. The truck carrying a reader can simply read a unique identifier from a tag in its proximity and determine its location using the stored associations.

In an aspect transceivers are distributed throughout a facility at known locations and mobile assets within the facility are provided with radio frequency transponders. In examples the transceivers can be battery powered and are arranged to be triggered when a mobile asset comes into range of the transceivers. Transceivers can be triggered by a mechanical actuator such as a pressure pad or switch or by a low power proximity detector such as a PIR sensor. Advantageously this permits the transceivers to be battery powered and reduces the frequency with which batteries must be replaces.

Derived location information can be communicated to systems associated with a mobile asset such as vehicle power controllers such as those described herein with reference to FIGS. 6, 7, 8 and 9 or authorisation control systems such as those described herein with reference to FIGS. 1 to 3.

In one aspect there is provided a positioning system for determining the location of a mobile asset in a facility, the system comprising:

a plurality of machine readable identifiers positioned about the facility; and

a memory storing an association between one or more positions in the facility and one or each of the plurality of identifiers; and

a mobile asset having a proximity reader for reading a machine readable identifier of the plurality of machine readable identifiers in reading range of the reader; and a processor, in communication with the reader and the processor arranged to determine a position of the mobile asset based on the stored association.

In one possibility the facility is a warehouse and in another possibility the facility is a dock, a freight terminal or an airport. Preferably the machine readable identifiers are positioned with a separation of at least five times the reading range of the reader. This provides a system which reliably reports a unique location without the need for complex positioning equipment. Alternatively or additionally the reader is provided with a directional antenna.

In one possibility the mobile asset comprises logic for comparing an identifier with a stored association to determine a position of the mobile asset based on the stored association. Advantageously this permits a mobile asset to obtain position information without communicating with any remote system. In one possibility the logic is configured to set idle time intervals and/or record operational parameters and/or send operational parameters and/or limit speed to a remote system in response to determining that the mobile asset is in a particular position (such as in one of the zones described below).

In an aspect there is provided a warehouse vehicle comprising a proximity reader for reading a machine readable identifier; and a memory storing an association between each of a plurality of identifiers and one or more positions; and comparison logic arranged to compare an identifier with a stored association to determine a position, for example in response to the proximity reader reading a machine readable identifier.

In an aspect there is provided a warehouse comprising a plurality of machine readable markers each marker associated with a location; and one or more warehouse vehicles comprising a proximity reader for reading the machine readable markers; and comparison logic for comparing information read from the markers with a stored association to determine a location of the vehicle.

In one possibility there is provided a warehouse wherein the one or more warehouse vehicles comprises a communication interface for communicating with the comparison logic. In one possibility the warehouse comprises a monitoring station operable to communicate wirelessly with the vehicle via the communication interface wherein the remote monitoring station comprises the comparison logic. Preferably the comparison logic is attached to the vehicle so that location information can be determined where immediate communication with the remote monitoring station is not available.

Typically a mobile asset comprises a communication interface for communication with a remote monitoring station, in these examples the remote monitoring station comprises the memory and a remote logic for determining the position of the mobile asset based on the stored association.

In an example a mobile asset is a warehouse vehicle such as a fork lift truck or other vehicle. The machine readable identifiers can comprise RFID tags, machine readable barcodes, two dimensional bar codes, tuned resonators such as those used in electronic article surveillance theft detection systems (e.g. LCR tank circuit coupled to an antenna), machine recognisable symbols such as shapes or numbers or non numeric markings or other capacitive, inductive or electronic marking systems. Whatever machine readable marking system is provided a corresponding proximity reader is provided, for example a proximity reader may comprise a broad band RF transceiver, a near field RF communicator (such as an RFID reader) or a digital video camera coupled to digital image recognition software for identifying symbols such as shapes or numbers or non numeric markings. Alternatively capacitive or inductive proximity readers are provided for reading the machine readable identifiers.

Typically in a warehouse environment a stored association comprises an association between one or more (or a group) of machine readable identifiers and a zone of the warehouse such as a particular aisle between storage units, or an area of a zone adjacent a particular storage unit, a waiting zone, an unloading zone (for goods leaving the warehouse) and a delivery zone (for goods being delivered to the warehouse). The zones selected for each example of a warehouse positioning system will vary dependent on operational need and the particular circumstances of each example. Alternatively a stored association may comprise an association between the absolute position (i.e. the GPS coordinates or map grid reference), or relative position (i.e. distance from selected reference points) and each machine readable identifier.

Memory may be provided in each mobile asset so that in response to the proximity reader reading an identifier, logic in the mobile asset can determine position information based on the stored association. In one possibility the memory is provided in a remote location (such as a location comprising a remote monitoring system or a communications relay such as a wireless hub or router) and identifier information read by the proximity reader is communicated to the logic in the remote location so that position information for the mobile asset can be determined based on the stored association and, as appropriate, the vehicle identifier.

In one example machine readable identifiers comprise passive RFID tags which may be ruggedised to withstand high pressures and/or impacts. Preferably ruggedised RFID tags are affixed to flooring of a warehouse and are potted in a shield structure comprising resilient and materials to protect the tag from being crushed. Preferably a ruggedised RFID tag is able to withstand compressive forces of between 7000N and 70000N and so can withstand the weight of most un-laden forklift trucks. Still more preferably a ruggedised RFID tag is embedded in a protective shield and is able to withstand compressive forces of 70 kN, still more preferably 700 kN.

In one method aspect the invention provides a calibration method for a warehouse positioning system the method comprising positioning machine readable identifiers throughout a warehouse and storing an association between each identifier and position information to enable operation of a warehouse positioning system according to other aspects of the invention.

In a method aspect there is provided a method of configuring a location monitoring system, the method comprising providing a position reference communicator at each of at least three known locations; and disposing at a first location a machine readable identifier and determining the first location based on communication with at least three of the at least three position reference communicators and storing in a memory an association between the identifier and the first location. In an example a machine readable identifier comprises a passive RFID tag or a two dimensional barcode.

In preferred examples an association can be stored for each of a plurality of locations. In one possibility an association is stored for each of at least 50 locations. Stored associations between identifiers and locations can be downloaded to a second memory for use in a mobile asset. The advantage of this procedure is that complex and accurate triangulation can be performed once in a “calibration step” subsequently no complicated processing or calculation is required and only simple equipment (i.e. an RFID reader and a memory) is needed to determine a position. The accuracy of this method is of course dependent on the triangulation method used and the communication range of the radio frequency transponders. In an alternative, machine readable identifiers may simply be resonant tank circuits tuned to a particular frequency, these may be read by a broad band transceiver so that rather than being identified by a numeric identifier each tag can be associated with a particular frequency, associations can then be stored between transponder frequency and location.

An identifier may be a unique identifier or may be associated with a set of tags. Alternatively a set of identifiers may be associated with one location or zone. Preferably an identifier is associated with a set of tags for example which may be used to indicate a zone or area of a facility such as a warehouse or a parking area.

As will be appreciated, features from any one method aspect may be implemented in combination with all or some of the features of another method aspect and features of any described method embodiment may be employed in combination with all or some of the features of any other method embodiment. Equally features described with reference to performance of a method also extend to (but do not require) specific hardware adapted to support that method.

### BRIEF DESCRIPTION OF THE SEVERAL VIEWS OF THE DRAWINGS

FIG. 1 depicts an authorisation control unit installed on a vehicle.

FIG. 2 depicts a driver access token coupled to a driver access token update system.

FIG. 3 depicts a warehouse facility having a facility access control and driver access token update system.

FIG. 4 depicts a schematic diagram of vehicle components and a CAN vehicle bus.

FIG. 5 shows a schematic representation of a warehouse with a facility control system.

FIG. 6 shows a schematic representation of a programmable vehicle power controller.

FIG. 7 is a schematic flow chart representation of operation of a vehicle power controller.

FIG. 8 is a schematic flow chart representation of a method of configuring a controller according to FIG. 6.

FIG. 9 shows a very schematic representation of a warehouse positioning system.

FIG. 10 shows a simplified schematic of an asset monitoring system.

FIG. 11 shows a simplified overview of the asset monitoring system of FIG. 10.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

### Authorisation Control Unit Example

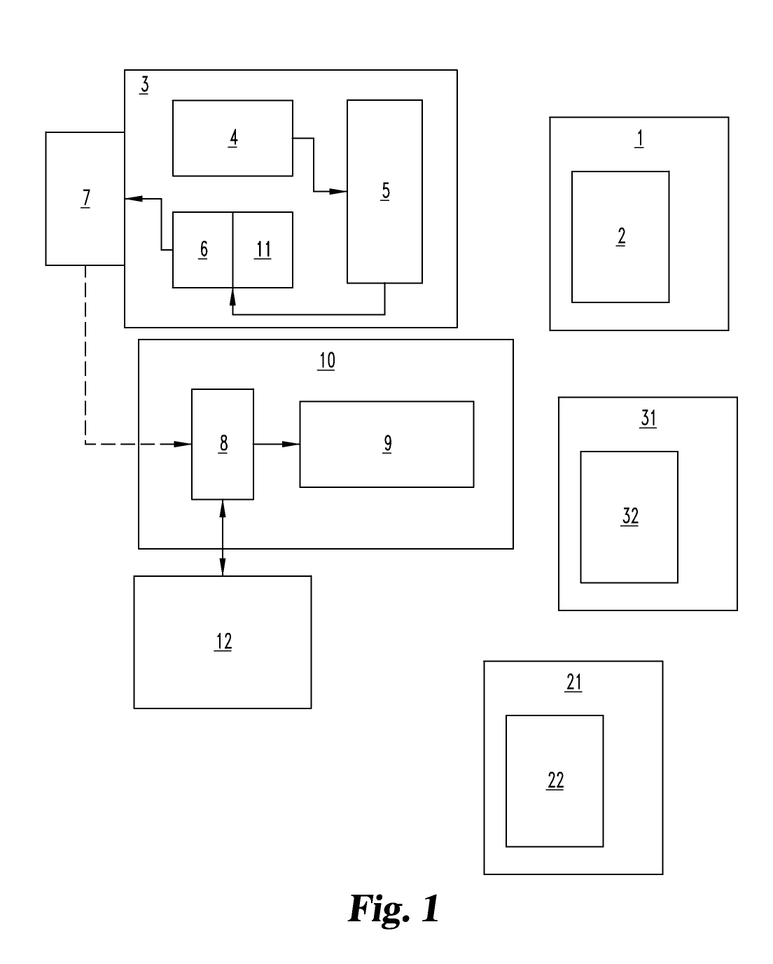

In the example of FIG. 1 an authorisation control unit 3 has vehicle identity logic 4 coupled to a near field RF communication interface 5. The near field RF communication interface 5 is coupled to driver record logic 6 and to enable logic 11 which in turn is coupled to a vehicle interface 7. When the authorisation control unit is mounted on a vehicle 10 the vehicle interface can be coupled to a secure enablement unit 8 coupled to control at least a part of vehicle functionality 12.

Vehicle 10 is a reach truck with an out rigging of telescoping forks that move up and down. The forks are suitable for lifting and manipulating pallets and also include hydraulics that allow the operator to pick up a load and reposition it over the outriggers and allow the forks to position pallets into shelving by sliding the pallet into place. Vehicle 10 is a stand-up reach model operable to slide forks under the pallet, transport it to the desired storage location, and slide it into place, typically these trucks are used for shelving units that are no deeper than required to place one pallet of goods. Optionally vehicle 10 may be a double deep reach or straddle reach truck that can not only slide under the pallet, but also grab the sides as well. Typically a facility such as a warehouse will make use of all these types of reach truck in addition to other types of materials handling vehicles and other vehicles which may have varying training or license requirements. The present invention is described with particular reference to such vehicles but, as will be appreciated these examples are provided by way of illustration and the invention is not so limited.

A plurality of removable, rewritable, functional access tokens 1, 21, 31 are provided for providing different levels of access to the vehicle 10 via the authorisation control unit 3: a driver token 1, a maintenance token 21, and a supervisor token 31.

The removable rewritable driver token 1 has a memory 2 coupled to a near field RF communication interface for communicating with the near field RF communication interface 5 of the authorisation control unit 3. Memory 2 stores a unique driver identifier and a list of vehicle identifiers to indicate vehicles the driver is authorised to operate.

The removable rewritable maintenance token 21 is similar to the driver token having a memory 22 coupled to a near field RF communication interface for communicating with the near field RF communication interface 5 of the authorisation control unit 3. Memory 22, however, stores a unique technician identifier, and information indicating the token to be a maintenance token which grants a technician level authority to operate all vehicles.

The removable rewritable supervisor token 31 is similar to the driver and maintenance tokens 1, 11 having a memory 32 coupled to a near field RF communication interface for communicating with the near field RF communication interface 5 of the authorisation control unit 3. Memory 32, however, stores a unique supervisor identifier, and information indicating the token to be a supervisor token which grants a supervisor level authority to operate all vehicles.

The vehicle identity logic 4 includes a memory which stores at least one vehicle identifier and at least one vehicle enable code. Communication interface 5 is arranged to read vehicle identity information from the vehicle identity logic and to read information using near field RF communication from driver or other tokens 1, 11, 21 in near field range. Typically, in operation, when a communication interface 4 detects a token 1, 11, 21 in near field range it transmits an RF signal which couples inductively with an inductive coupling element of the driver token. Using electric power derived from the inductively coupled RF signal (or using an integrated power supply) the token communicates stored driver, maintenance, or supervisor authorisation information back to the communication interface 5.

Driver authorisation information comprises a unique driver identifier code and a list of vehicle authorisation codes. As the communication interface 5 reads the driver authorisation information it can communicate the unique driver identifier to the driver record logic 6. Listed vehicle identifiers are compared with vehicle identity information stored by the vehicle identifier logic. In the event that a listed vehicle identifier matches stored vehicle identity information the enable logic 11 generates an enable signal for the vehicle based on matching the vehicle identifier for the vehicle on which the authorisation control device is installed with one of the vehicle identifiers in the list of authorised vehicles stored in the token. The enable signal may be configured (e.g. coded) only to activate a particular vehicle to prevent unauthorised removal and transfer of authorisation units between vehicles. The driver record logic makes an entry in a non-volatile memory to record a vehicle authorisation and communicates an authorisation signal to the vehicle interface 7. Advantageously the authorisation system is self contained and no real-time communication to an outside system or database is required for authorisation. The device does not require complex logic to determine whether the driver is authorised; instead it simply needs to match its own vehicle identifier with the list stored on the driver token.

Technician level and supervisor level authorisation information each comprises a unique respectively, and the information indicating the token to be a maintenance token or a supervisor token respectively, which information indicates authority to operate all vehicles. As the communication interface 5 reads the technician or supervisor authorisation information it communicates the unique technician or supervisor identifier to the driver record logic 6. The information indicating the token to be a maintenance token or to be a supervisor token is compared with the technician/supervisor identification data stored by the vehicle identifier logic to allow identification of the token as a maintenance or supervisor token respectively. In the event that the token is a maintenance or supervisor token the enable logic 11 generates an enable signal for the vehicle.

The technician or supervisor identifier code may use a similar or identical coding scheme to that of the driver identifier code. The information indicating the token to be a maintenance token or a supervisor token may be an attribute set on the token, for example, a token type identifier.

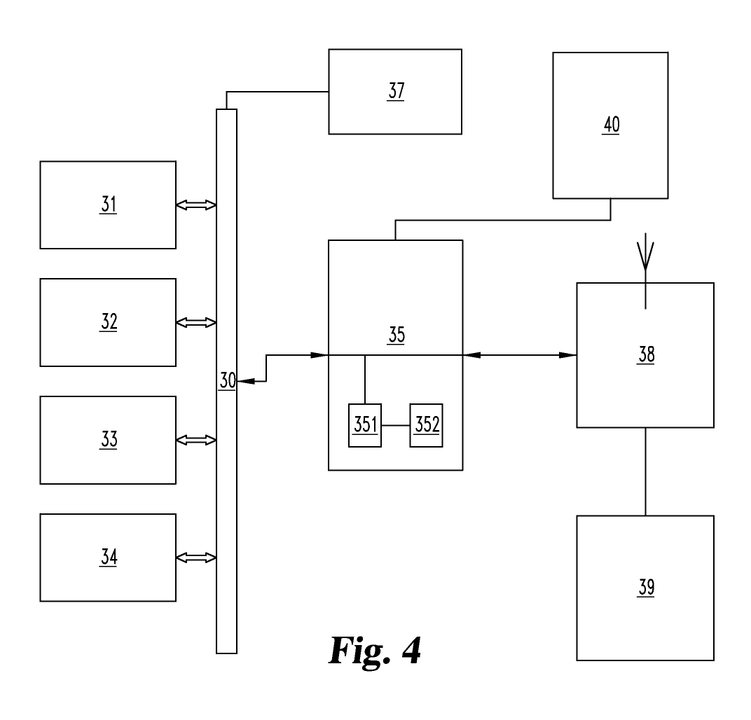

When the token is identified to be a maintenance token the authorisation unit provides a maintenance menu to the holder of the token via an associated display. This menu allows the holder to interrogate a maintenance interface (for example as described in more detail with reference to FIG. 4 below) to extract maintenance related parameters for fault diagnosis purposes. The menu also allows the token's holder to disable the vehicle by means of the enable logic. The enable logic is configured, once a vehicle is disabled by a holder of a maintenance token, to prevent further attempts to access the vehicle by holders of driver tokens, even by those normally authorised to drive the vehicle.

When the token is identified to be a supervisor token the authorisation unit allows the holder to re-enable the vehicle. The enable logic is configured, once a vehicle is re-enabled by a holder of a supervisor token, to allow further attempts to access the vehicle by holders of driver tokens carrying authorisation to drive the vehicle.

In the event that no listed vehicle identifier matches stored vehicle identity information, and the token is not a supervisor or maintenance token, the driver record logic makes an entry in memory to record a failed vehicle authorisation attempt. It is desirable for the authorisation control unit 3 to provide information to a user to indicate a successful or unsuccessful authorisation. Repeated unsuccessful authorisation attempts may trigger a lockout period during which no further authorisation attempts will be accepted. A user indication, typically a red light or low pitch tone may be provided to indicate this status to a user.

In one embodiment, during operation of the vehicle the communication interface communicates periodically or intermittently with the removable rewritable driver token 1 to ensure that the driver token has not been removed. In the event that, after operation of a vehicle has commenced, a secure driver access token is not detected by the communication interface an alert procedure is triggered by enable logic 11. Alternatively the vehicle may be activated for a predetermined period (e.g. a shift period, an interval between prescribed breaks) which may be configurable. An alert procedure may comprise initiating a visible and/or audible alarm signal, gradually reducing the vehicle speed if the vehicle is in motion until the vehicle become stationary, preventing the vehicle from moving if it is stationary, disabling at least one function of the vehicle, recording an event using an event logging buffer and communicating over a wireless communication interface with a remote device to call a supervisor or other authorised operator.

In another aspect there is provided an interface device for a vehicle having a control bus over which vehicle parameters are passed comprising a vehicle interface for communicating with a control bus of the vehicle; a wireless interface for communicating data packets with a remote server; buffer memory for storing packets to send over the wireless interface; and a processor for controlling communication, wherein the processor is arranged to detect whether wireless interface is available for live transmission to the server and to select information for transmission or buffering based on availability. In this way, the vehicle can operate robustly with an intermittent interface, contrary to some prior designs which go to great lengths to ensure a site will provide a reliable communication path. In the event the interface is unavailable, only higher priority data may be stored for subsequent transmission when the interface becomes available again.

An interface device typically will have a further memory for storing information separate from the buffer, wherein the processor is arranged to respond to a query received over the interface to transmit information stored in the further memory on request. The further memory may store detailed vehicle parameters and history and portions of it may be queried, either by reference to parameter labels or to memory addresses or both, or in response to a memory dump request. As in the previous embodiments, the parameters may be CANBUS parameters.

In some examples an operator communication interface arranged to store operator input received when the interface is not available for transmission at a time the wireless interface is available.

In this way, an operator (driver) may return information to base but need not be in direct communication at all times. The operator input may be active, for example an operator keying information into a terminal or keypad or passively collected, for example an operator presenting an authorisation token or taking an action may trigger an operator input signal without direct (other) intervention by the operator.

In some examples the wireless interface is a telecommunications interface having a data transmission protocol and a text message protocol wherein the apparatus is arranged to format data into messages suitable for transmission by the text message protocol in the event the data transmission protocol is unavailable.

Whereas a GPRS (or 3G) protocol is well known for GSM type modems, in some locations, it can be unreliable and less robust than an SMS protocol. According to this aspect of the invention, the interface may continue to operate (albeit at reduced data throughput) if only SMS communication is available. In conjunction with the prioritisation functions, a highly robust remote interface may be provided. In other applications, a Wifi 802.11 (b/g/n etc) communication link may be provided.

In one possibility the processor is arranged to communicate operator information bi-directionally with an operator console or operator application. Therefore, there is provided a server for communicating with a plurality of remote vehicles each having an interface device the server comprising vehicle data memory for storing vehicle information received from a plurality of vehicles and operator information memory for storing operator information received or messages for transmission to the operator. In some examples the server is arranged to make the vehicle data memory available to a first application and the operator information memory available to a second application.

In this way a maintenance application may access vehicle parameter records and may transmit queries for further remote diagnosis and a management or workflow planning or timekeeping application may communicate with the operator or make use of the operator data, over the same (robust) communication interface.

In the example of FIG. 1 enable logic 11 is configured to co-operate only with a particular vehicle having a particular secure enablement unit 8. Communication between enable logic and the secure enablement unit can be preceded by a secure handshake in which the enable logic provides the secure enablement unit 8 with a unique vehicle identifier and in the event that the unique vehicle identifier does not match a value stored in the secure enablement unit at least one operation of the vehicle is inhibited. Therefore if vehicle authorisation control unit 11 is swapped onto a different vehicle without authorisation (reprogramming of vehicle identity logic 4) then at least a part of vehicle functionality 10 will be disabled. In other embodiments, the vehicle identifier is read from the vehicle so the authorisation control unit can be swapped between vehicles without the need for reprogramming. In others the ID is stored programmably.

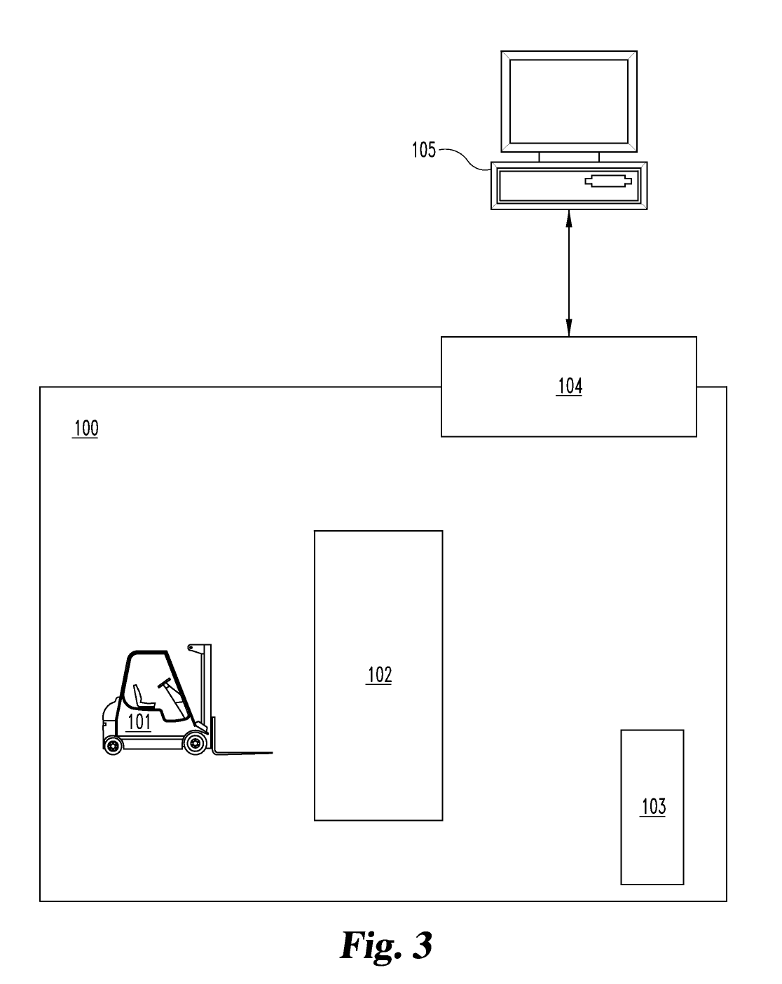

Driver record logic 6 comprises a non volatile memory and a read/write interface to permit data to be written to and read from the non volatile memory. Once an operator has been authorised to operate the vehicle the unique driver identifier is recorded and an event log, associated with that driver identifier is created and maintained. An event log typically includes time and date information, one or more event indications and particular operational parameters of the vehicle during operation by that driver. For example an event indication may be an accelerometer or tilt switch indication to provide a record that a vehicle has been tilted or has suffered an impact. Typically only events which exceed a threshold (for example a threshold acceleration/impact or a threshold tilt angle) are recorded, thereby the authorisation device is able to obtain and record a unique driver identifier or pass it on to other systems (e.g. remotely) for use for example in identifying an individual driver in the event of an incident. Incident reporting and monitoring is described below in greater detail with reference to FIG. 3.

Driver access token 1 comprises a memory 2 storing user interface information readable by vehicle authorisation control device 3. User interface information read from driver access token 1 is used to configure a user interface 12 of the vehicle. User interface 12 comprises controls 13 configurable by the user interface information to provide control of one or more operations of a vehicle. User interface information selectably configures controls 13 to control functions of vehicle 10 for example start and stop and in some embodiments may include directional movement controls, lift extent and reach of the truck. By controlling configuration of the user interface operating permissions of a user can be provided in a way that cannot be overridden by the user.

As described above, different vehicles have different capabilities and such vehicles may require different levels of training and/or authorisation in order to ensure safe and effective operation and to comply with regulatory standards, for example health and safety standards. In addition different users may be permitted to operate vehicles in different ways, for example certain users may be permitted only to operate vehicles carrying loads less than a selected limit and or to operate vehicles below a restricted speed or not to extend the manipulation arms (forks or straddle reach) of the vehicle beyond a given height or extent.

User interface information can configure controls 13 to provide operator access to selected features. For example a user who is a technician or vehicle engineer can be provided with an access token 1 configured with a technician attribute as mentioned above. On presenting such a token the technician is presented with user interface information to provide access to some or all of the diagnostic and/or maintenance functions of a vehicle. Normally there will be a limited number of “superusers” such as a supervisor or a technician. A supervisor has a supervisor attribute set (for example a binary identifier associated with the token) which may authorise the supervisor to drive any vehicle without requiring a vehicle identifier match and/or enable the supervisor to reset alarms or enable a vehicle after an incident in which operation of the vehicle has been disabled by the authorisation control unit. Certain vehicles may be more technically complex than others or require different maintenance training. It is possible that certain maintenance tasks may require a technician attribute and/or a vehicle identifier match. Without a vehicle identifier match a technician may be authorised only to disable a vehicle to prevent use of the vehicle before maintenance is complete and to operate certain diagnostic functions of the vehicle. A technician with a vehicle identifier match may be authorised to carry out the full range of diagnostic and maintenance functions. As noted a user who is a supervisor may be authorised to operate all functions of a vehicle and to override certain time lock-out and alarm functions. As will be appreciated in the context of the particular examples provided, other examples of specific attributes giving “special” permissions based on user interface information may be employed. Example user interfaces include sets of buttons with corresponding visual indicators to indicate the function each button is configured to provide, alternatively or additionally a user interface includes a touch sensitive screen upon which a set or sets of menus and configurable soft keys can be provided to provide configurable user controls 13.

Information for configuring the user interface may be stored on the driver access token 1 and/or stored on the authorisation control device 3 and activated dependent on information stored on the token. Authorisation control unit 3 uses a high performance 16 bit microcontroller to run a configurable application to manage and report on the vehicle operators. The activity of the operator is logged for reporting to a control room. Typically communication interface 5 uses a MIFARE™ contact-less RFID card to store the user profile and access rights. Authorisation control unit 3 can be powered from an automotive power source (12 or 24V) and ideally is tested to ISO 7637 standards.

As described in more detail above, different operating modes can be selected and authorisation control unit 3 can shutdown the equipment in the event of an impact or excess idling. To provide this and additional functions a secure authorisation and control unit can be coupled to a vehicle control system such as a CAN-BUS to allow microcontrollers and devices to communicate with each other within vehicle 10 without a host computer. Preferably monitoring and control data read from the CAN BUS is communicated to a remote device via the authorisation control device. Communicated information can include for example: service hours; current, minimum and maximum engine speed (rpm); current, minimum and maximum oil pressure; current, minimum and maximum water temperature; and other diagnostic parameters. Odometer information may also be provided including vehicle idle time, vehicle speed, fuel economy (instantaneous and running average values). In preferable embodiments a second CANBUS interface is provided.

Other parameters which may be usefully monitored include all basic instrumentation information, the machine serial number, traction and hydraulic hour meters, speed and battery voltage, motor and pump temperatures and fault codes. In one embodiment the power requirements of an authorisation control device are less than 5 Watts and the device may be operable over a voltage range of between 6 and 30 Volts DC.

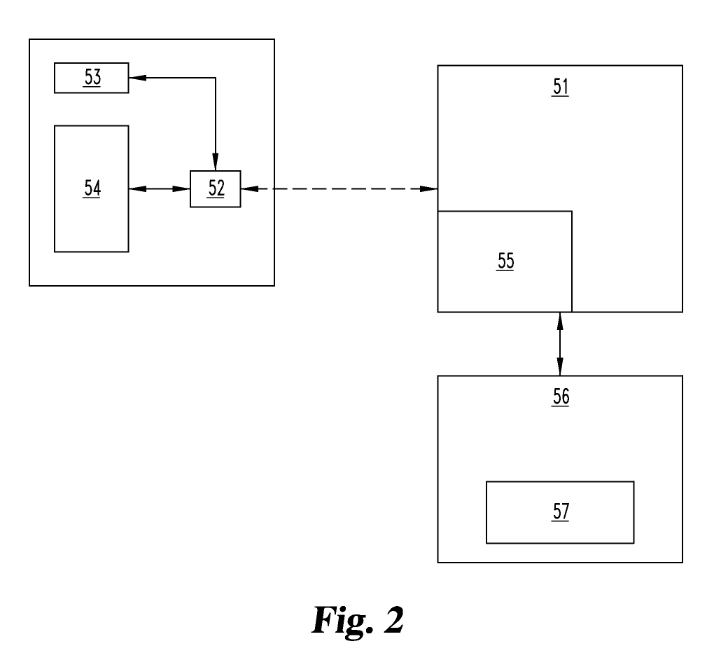

The example of FIG. 2 shows a driver access token 50 coupled to a driver access token update system 51. Removable rewritable driver token 50 has a communication interface 52 coupled to read and write data to a memory storing a unique driver identifier 53 and to read and write data to a memory storing a list of a plurality of authorised vehicle identifiers 54.

Driver access token update system 51 comprises a communication interface 55 for communicating with communication interface 52 of a driver access token. Update system 51 is coupled to a controller 56. Controller 56 typically provides processor functionality comparable to a personal computer and operates using facility access software 57. The token 50 is couplable to the update system 51 via communication interfaces 52 and 55 to communicate (i.e. read and write) data between memory held on the token and the update system. The token 50 is marked with visible text and/or a photo ID and may also store data for use by a facility access control and monitoring application for monitoring time and attendance and/or providing secured access to a building.

Driver access token update system 51 comprises an access point to which a driver may present a token, for example on “clocking on” for work and gaining access to the facility in which he is to work. The access point includes reader circuitry for reading the token to recognise a unique identifier of the token and writing logic for updating the list of authorised vehicles stored on the token. Each time a driver presents the token to an access point to gain access to the facility, the list of vehicles he is authorised to may be updated at that time. In this way no complex communication between a central controller and vehicles within the facility is required and a simple list of vehicle authorisations can be written to access card memory by taking advantage of a routine daily process and without the operator or supervisor needing to perform any additional tasks. To support this function a software platform is provided which contains a list of vehicle access permissions for each operator and one or more pieces of user interface information. This application maintains a list of functions an operator is permitted to use in the control, and/or maintenance and repair of vehicles and interfaces with infrastructure in a facility (such as a warehouse) to manage.

### Warehouse Facility Example

A warehouse facility is illustrated in schematic form in FIG. 3 in which a warehouse facility 100 houses a mobile asset 101, a plurality of moveable stationary assets 102 and a wireless communication relay 103. Access to the facility is controlled by management system 104 (which includes features of the driver access token update system 51 described above with reference to FIG. 2). Management system 104 is in communication with user interface and control means 105.

Mobile asset 101 is configured to communicate wirelessly with management system 104 via communication relay 103. Mobile asset 101 carries an authorisation control device 3 as (described above with reference to FIG. 1) which stores information for communication with management system 104. Stored information is stored in a buffer local to the authorisation control device 3 and is communicated to the communication relay when a clear communication channel is available. Thereby, in the event that mobile asset 101 moves moveable stationary assets 102 in such a way that modifies the wireless communication environment or is simply out of radio contact, no immediate problem results as information is stored and can be transmitted when communication is re-established. This addresses the disadvantages of some prior art systems in which real-time information is required to be sent directly to a management system and provides a robust communication and management method in an unpredictable radio environment.

In an example event information is stored locally and only transmitted if impact or tilt information associated with an event exceeds a threshold as described above. This further improves the robustness of the system by reducing bandwidth demands on the communication. In addition, when an event is detected a technician or supervisor can review a comprehensive record of the vehicles operation without the need to transmit large volumes of information over a wireless link.

Management system 104 and/or user interface and control means 105 is configurable with software to report stock volumes and operator attendance information for stock monitoring and control. The software can be provided with an interface for modifying per vehicle permissions of an operator based on information held in other applications or systems, for example in personnel records. Advantageously sensitive asset control permissions can be controlled with reference to centrally held and verified personnel records, for example training certificates and other information.

Updates may be processed at separate times and simply updated at next presenting of the token. In one example a driver token may be provided as part of an ignition key or a key fob.

In some embodiments or aspects the invention provides methods of updating the memory of the token by providing an incremental update of the token memory, for example by overwriting a single memory entry, groups of memory entries or overwriting the entire memory. Similarly embodiments or aspects may provide methods of querying the memory of the token by providing a stepwise (sequential) query of the token memory, for example by reading a single memory entry, reading groups of memory entries or reading the entire memory.

To determine whether an operator is authorised for a particular vehicle communication interface 5 reads a list of a plurality of vehicle identifiers from a non volatile memory of a secure access token 1. Each vehicle identifier is compared with at least one stored vehicle identity attribute derived from the vehicle identifier logic.

Enable logic 8 (FIG. 1) can be configured to provide an authorisation signal based on a match between a vehicle identifier stored on a secure access token 1, 50 (FIGS. 1 and 2) without looking up a driver identifier. As described above, in a warehouse facility the secure authorisation unit 3 will typically have only an intermittent communication link to management system 104 105. Secure authorisation unit 3 (FIG. 1) permits an authorisation to be given without requiring a response from central computer in response to presenting a token programmed with correct permissions. To provide enhanced security and control functions while permitting flexible operation the secure authorisation unit is arranged to authorise vehicle in response to a match and to buffer driver ID and communicate it to central computer when a communication link become available, for example when a link with communication relay 103 provides at least a threshold quality of service or error rate.

In environments where the available communications bandwidth is limited, or to provide improved battery performance the authorisation control device 3 is arranged to communicate driver identification information following an incident or an event such as a detected impact. To provide similar advantages authorisation control device 3 is arranged to communicate driver identification information in response to a command received over a second communication interface and/or from central computer. When an event or incident such as an impact is detected at least part of vehicle functionality 9 may be disabled and require a reset authority before permitting the vehicle operation to continue.

### CAN Vehicle Bus Example

In FIG. 4 a schematic diagram of vehicle components includes a CAN vehicle bus 30 to allow microcontrollers and vehicle systems to communicate with each other, for control and monitoring functions within the vehicle. The CAN 30 is arranged for communication between hydraulic system 31, engine 32, speed and directional control systems 33 and battery control system 34 and other vehicle systems (not shown).

A control unit 35, such as an authorisation control unit, is coupled to a non volatile memory 40 and is arranged to read information from the CAN BUS 30. Typically, control unit 35 comprises logic 351 coupled to a memory 352 storing programmable reporting thresholds (minimum or maximum levels) and/or ranges. An event indicator 36 is coupled to the control unit 35. FIFO CAN buffer is coupled to the CAN 30 and to control unit 35. A vehicle communications interface 38 is provided with communications buffer 39.

FIFO CAN buffer 37 provides a first-in-first-out buffer memory to record the status of the CAN over a period of time. Control unit 35 is configured to read the contents of the FIFO CAN buffer 37 into non volatile memory 40 in the event that event indicator 36 indicates that an event is detected. Control unit 35 may poll the event indicator periodically (or in round-robin fashion if more than one event indicator is present) or may be arranged to receive an interrupt signal transmitted by event indicator 36 to trigger the contents of the FIFO CAN buffer 37 to be dumped into non volatile memory 40.

Generally, to avoid clashes on the CAN BUS, the FIFO CAN buffer is coupled to the CAN as a receive-only node (i.e. it does not transmit any messages on the BUS). As will be appreciated in the context of the present application, each node is typically able to send and receive messages, but not simultaneously. Generally a message includes an identifier to indicate the message-type and/or sender—and up to eight message bytes. Messages are transmitted serially onto the bus, one bit after another. The FIFO buffer is programmable to monitor CAN traffic relating only to particular devices or vehicle systems by filtering using the CAN identifier. To increase the period of time over which CAN data may be recorded by the FIFO buffer the FIFO buffer preferably is programmable via selection parameters to buffer only a subset of transmitted CAN information (i.e. CAN messages having particular device identifiers and/or message type). The selection parameters for this CAN message filter may be configured remotely, for example by a diagnostic engineer at a remote terminal in communication with the vehicle.

The use of a CAN buffer enables the state of the CAN before any given event to be known, it is not required to record all CAN information and it is not required to transmit CAN information in real time. In response to particular CAN events (CAN parameters exceeding certain programmable thresholds or ranges) or other events the contents of the buffer can be transmitted and/or dumped into a local non-volatile memory (such as a hard disk or flash memory). This enables the occurrence of events to be monitored without the need for real-time communication which is costly in terms of bandwidth.

Information available for reading from the CAN bus 30 includes hydraulic pressure, oil pressure and temperature, lift time, move time, vehicle speed, brake operation, brake fluid levels and pressures, coolant temperature, battery charge levels and other vehicle information. As will be appreciated by the skilled practitioner the foregoing list is illustrative only and in any particular case fewer or more parameters may be available to be read from the CAN-BUS.

During usual operation of the vehicle control logic 30 is arranged to read information from the CAN bus and to compare information with one or more programmable reporting thresholds or ranges. A threshold or range may be programmed for any or all information which is available to be read from the CANBUS.

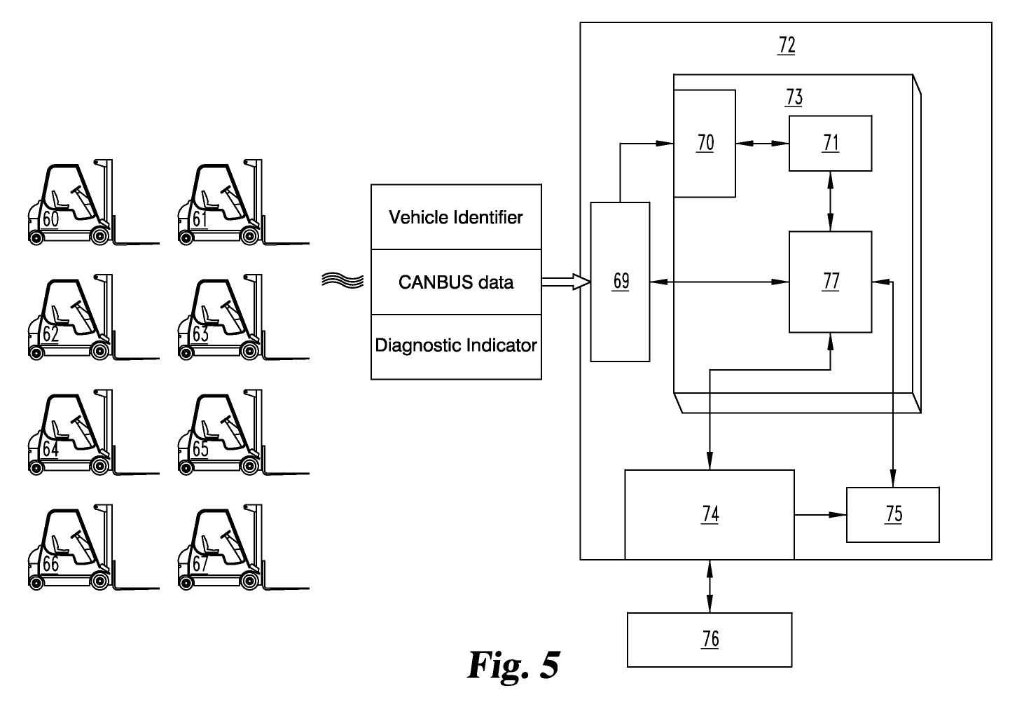

On the basis of a comparison between CAN information and one or more thresholds and/or ranges (as described above) control unit logic 351 may determine to report and/or record current CAN information using communication interface 38. Communications buffer 39 provides local storage of communication information. Buffered communication information can be transmitted directly, buffered temporarily before transmission, stored in non-volatile memory 40 and transmitted subsequently, for example in the event that the communication buffer 40 overflows. This technique enables transmission to take place when transmission conditions are favourable or when a request is transmitted by a facility control station (for example a system such as that described below with reference to FIG. 5). By this method the need for real time communication can be entirely avoided thereby increasing transmitter battery life, reducing bandwidth requirements (for example by transmitting information when higher bandwidth is available) and enabling vehicle operation and diagnostic information to be monitored in a manner that is robust and reliable.

Communications interface 38 may be a discrete unit or it may be integrated into other vehicle functionality or provided by or included in an authorisation control unit substantially as described herein with reference to FIG. 3.

An event indicator 36 may include an alarm button, an accelerometer, a tilt switch, a gyroscope and/or a location determiner (such as GPS or a robust local location determining system such as the RFID grid described herein below).

Asset performance monitoring is performed based on CAN information and other event indicators collected in each asset using the systems described. Associated with each vehicle is a performance score which is calculated based on vehicle parameters. Systems in a vehicle may be subdivided between critical systems and performance support systems. For example an asset may still operate safely and effectively, albeit sub-optimally with a lower than ideal tire pressure or slightly reduced oil levels or hydraulic pressure. Such parameters are referred to herein as non-critical parameters (i.e. those not mandated by safety requirements or operating needs of an asset) and may be given integer values between 1 and 100 to indicate a percentage score. Certain other parameters, for example oil temperature, fuel level, battery level and coolant levels may be considered critical parameters. In other words, if these values are not within a given range safe and/or effective functioning of the vehicle is prevented. Within certain ranges critical parameters may be considered non critical and may be assigned a score which contributes to the overall performance score of the vehicle. An overall performance score can be assigned for example as P, where

$$P = {\prod }_{i = 1}^{N} {X}_{i} {\sum }_{j = 1}^{M} {Y}_{j} \qquad ( 1 )$$

In equation 1 above Xᵢ indicate critical parameters, which are binary indicators. If any critical parameter is zero the overall system score is zero and the asset is considered non-functioning. Each term Yⱼ indicates a score associated with a non-critical parameter, as will be appreciated certain parameters which are critical parameters outside certain ranges may be considered critical if they go beyond permitted ranges. Therefore the same vehicle system may contribute to the overall performance score P as both a critical and non critical parameter. Other methods of calculating a performance score will be apparent to the skilled practitioner in the context of the present application and any appropriate method may be chosen dependent on the particular constraints of a given situation. Whatever performance scoring system is used each vehicle is associated with an indication which can be used to assess when (i.e. how soon) maintenance actions may be required or for how long such actions can be postponed. Preferably the indication is accompanied by at least some diagnostic reporting information such as selected CAN BUS information, impact or tilt indications and/or fault codes.

### Facility Control System Example

The diagram of FIG. 5 shows a plurality of mobile assets 60, 61, 62, 63, 64, 65, 66, 67, 68 each of which comprise a communication interface for wireless communication 69 with a local communication interface of a facility control system 72. The facility control system comprises a controller 73 coupled to communicate with one or more of the mobile assets via local communication interface 69 and to communicate with remote station 76 via wide area communication interface 76. The facility control system 72 comprises a non-volatile memory 75 coupled to controller 73. Controller 73 comprises control logic 77, vehicle diagnostics logic 70 and correlator 71. Controller 73 is arranged to communicate with local communication interface 69 to monitor received vehicle information (for example vehicle information transmitted by a system substantially as described with reference to FIG. 4) and to transmit vehicle control and information messages via wireless communication 68.

A first vehicle 63 is arranged to communicate vehicle information with local area communication interface 69, the vehicle information comprising vehicle identifier information, CANBUS data and a diagnostic or event indicator such as a fault code. Based on CANBUS data, diagnostic or event indicator information a performance score can be calculated for each vehicle. Dependent on the particular constraints of each application the performance score may be calculated in each vehicle and transmitted to facility control system 72 or required information can be collated centrally so that a score can be assigned. Alternatively a mixture of these two approaches can be employed.

In general operation a vehicle will communicate information with the facility control system on a periodic or intermittent basis so that the vehicle status can be tracked. Real-time information is not communicated to avoid placing an undue burden on the communications network. Periodic or intermittent updates can be sent or event driven updates may be or buffered/recorded as described above in response to performance score changes or other events.

Correlator 71 maintains a table of vehicle status information comprising a plurality of vehicle status entries including performance scores. In this example each vehicle status entry is determined by vehicle diagnostics logic 70. Vehicle diagnostics logic and correlator 71 co-operate to determine a likely maintenance schedule for each vehicle based on at least one of a performance score or a performance indicator.

Vehicle components may have a finite predictable life which depends, inter alia, on factors including mileage, engine RPM, oil pressure and temperature and other engine parameters. Where appropriate the time integral and/or the average of these parameters may be used to predict the lifetime of components by reference to manufacturer's data sheets or historical data obtained from asset locations.

On the basis of a diagnostic indicator or an event indicator control logic 77 determines whether the received information relates to a routine maintenance status update or to an event indication.

### Power Controller Example

### Power Controller

### Overview

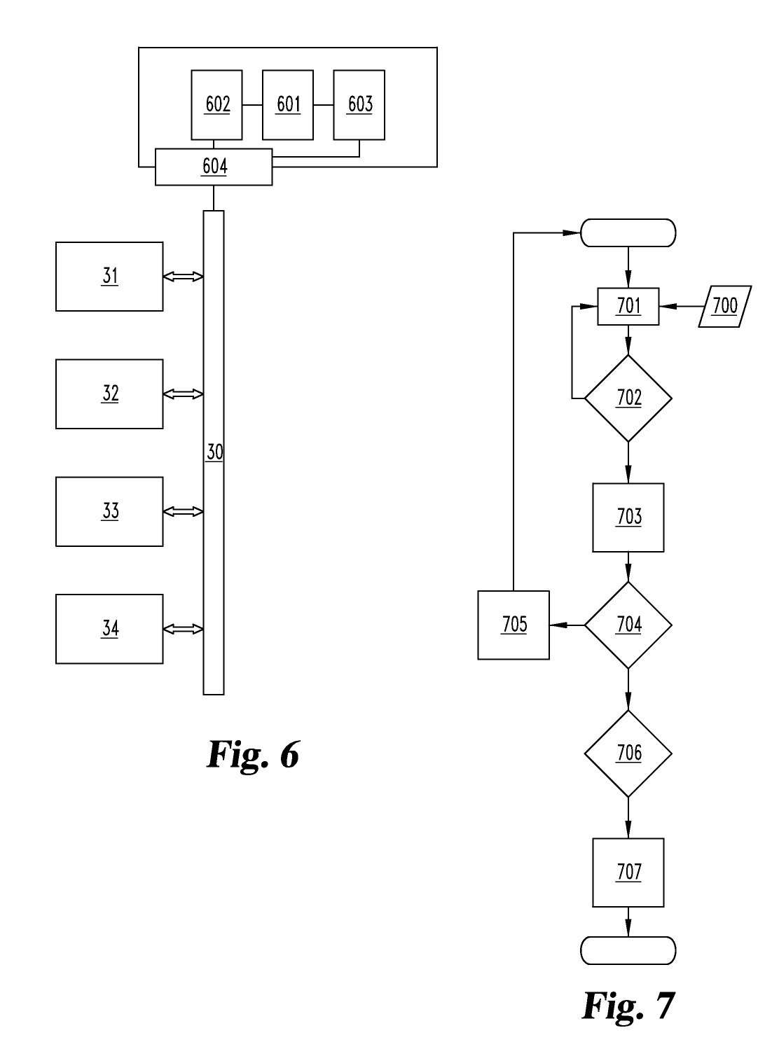

In the example of FIG. 6 a diagram of a programmable vehicle power controller is shown comprising a timer 601 and a vehicle idling sensor 602 coupled to the timer and to the CANBUS 30 of the vehicle (not shown) to sense whether the vehicle is idling. CANBUS 30 is coupled to communicate CAN messages with a plurality of vehicle systems 31, 32, 33, 34.

A switch arrangement (shutdown controller) 603 is coupled to the timer 601 and is arranged to shut down a power supply in the vehicle in response to the timer indicating that a time interval has elapsed. The vehicle power controller 600 is provided with a communication interface 604 to receive commands and/or other information. The programmable vehicle power controller 600 is programmable to set the time interval based on one or more received commands and/or other information, such as CAN messages.

For connection to the CANBUS, communication interface 604 comprises a host-processor to parse received messages to determine their type ID and their content and to transmit messages on to the CANBUS. Further sensors, actuators and other control devices can be connected to the host-processor. The communication interface further comprises a synchronous clock to control the rate at which, the interface 604 reads bits (one by one) from the bus. Messages for transmission onto the BUS are stored by the host-processor and the bits transmitted serially onto the bus. As will be appreciated, signal level regulation and other adapters are applied to provide suitable voltage transmission onto the BUS and to protect electronics from overvoltage conditions. On a BUS of a length typically found in a vehicle (20 metres or less) bit rates up to of up to 1 Mbit/s are provided. The CAN protocol standard is described in greater detail in ISO 11898-1 (2003) the entirety of which is incorporated herein by reference.

In FIG. 6 the switch arrangement 603 is provided by an interface to the CAN operable to send an “engine off” message to the ignition system or other power control system of the engine. In this example the communication interface 604 includes the CAN interface and can further include a wireless communication system such as a wifi interface, GSM GPRS, UMTS or other wireless interface.

### Power Controller

### Operation

The flow chart of FIG. 7 provides a schematic representation of operation of a vehicle power controller in which an idling indicator 700 is received by the controller at 701 which determines 702 whether the engine is idling. In the event that the engine is idle the timer is started 703. If, at 704, it is determined that the engine has ceased to be idle then the timer is reset 705. In the event that the engine remains idle until the time limit is determined at 706 to have expired a control signal is provided, for example using switch arrangement 603, to switch off the engine.

It will be appreciated that engine switch off will be subject to safety interlocks/fail safes to avoid the engine being switched off in a dangerous situation. The safety interlocks/fail safes may, for example, take account of the presence or absence of a driver (determined by means of a pressure sensor in the driver's seat). Furthermore, typically the safety interlocks/fail safes will not allow the engine to be switched off remotely when measured parameters indicate that a load is being lifted and/or held.

### Power Controller

### Time Interval Configuration

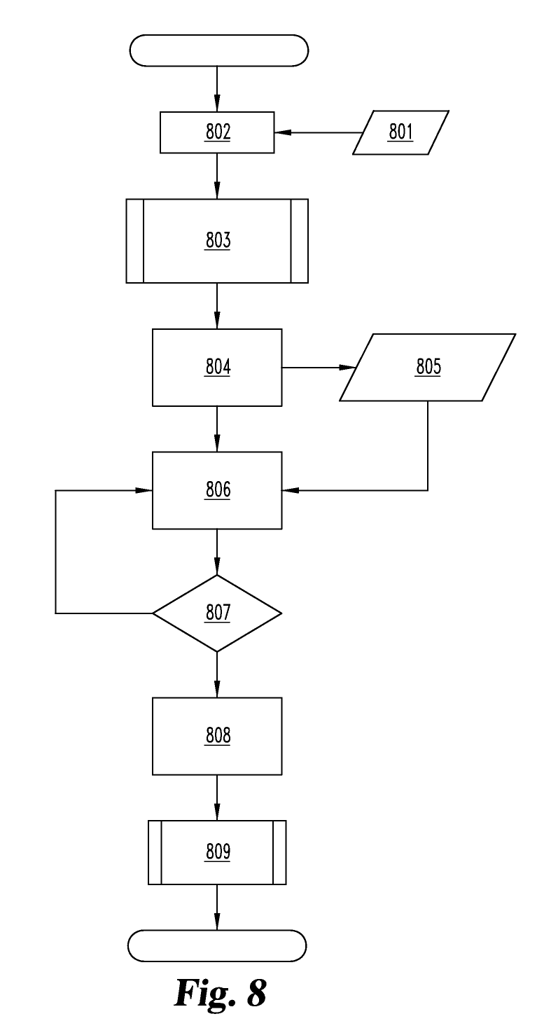

The flow chart of FIG. 8 shows a representation of a method of configuring the time interval such as for use in a controller according to FIG. 6. A command 801 provides configuration information which is received at 802 and processed at 803 to determine criteria for modification of the time interval dependent on CAN message information. In response to the process output, based on the received command the vehicle power controller is configured at 804 to monitor the CANBUS for CAN messages associated with a particular vehicle system (for example having a particular type identifier 805) such as a fuel gauge reading and/or a battery level reading. One or more CAN message type identifiers are written into a memory and, at 806 messages associated with that CAN message identifier are read from the CANBUS to derive device information associated with that type identifier. In the event that a message of the identified type is received the message is parsed and, in the event that it is determined that the time interval needs to be updated the timer is updated accordingly and monitoring of idle time is then performed according to the process described above with reference to FIG. 7.

### Asset Positioning Example

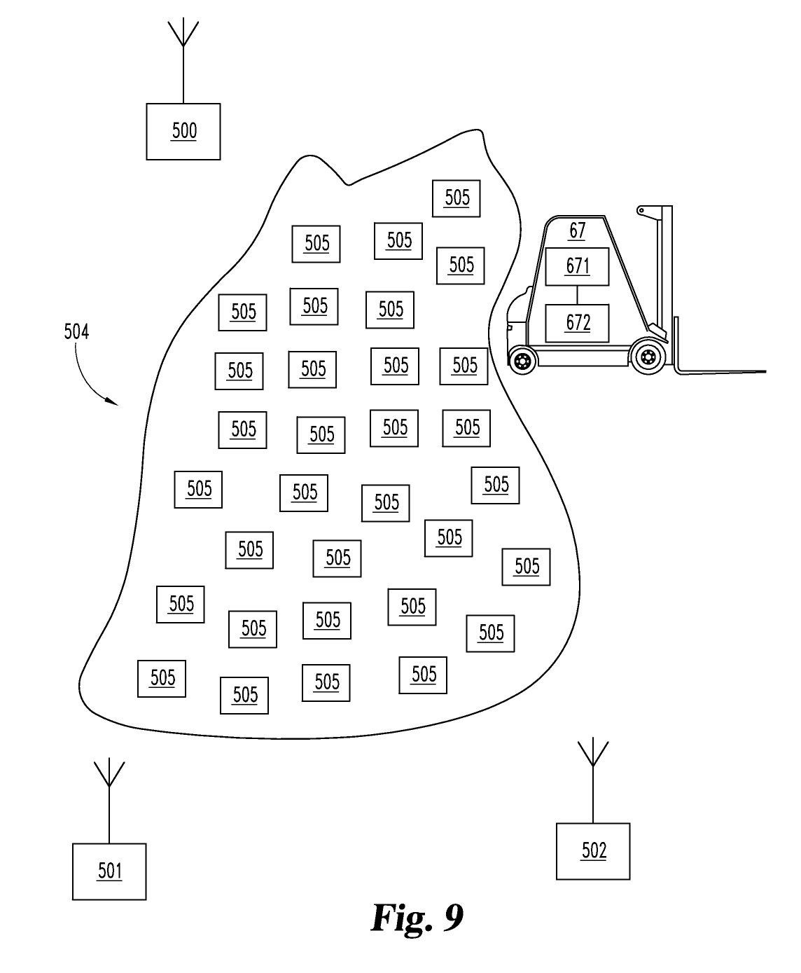

FIG. 9 shows a facility 504 in which a plurality of passive RFID tags 505 is distributed at fixed locations. Disposed about the facility, at known reference locations are at least three reference communicators 500, 501, 502. A mobile device 67 in wireless communication with reference communicators comprises an RFID reader for reading the plurality of RFID tags and a memory 671 coupled to the reader.

In a calibration step the mobile asset traverses the facility 504 while triangulating its position between the at least three reference communicators 500, 501, 502 via wireless communication. As the facility is traversed each RFID tag is read and the tag data is stored in the memory 671 along with triangulated position information. Thereby a stored association is created between each tag (or each of a plurality of sets of tags) and triangulated location information. Clearly, triangulation is not required, GPS information could be used for this triangulation step. In certain facilities (for example underground facilities or facilities with heavy/dense/radio opaque superstructures) GPS signals are not available or are of insufficient quality to provide sufficiently accurate location information.

Logic functions and determining and aggregation steps described herein may be implemented by programming computing apparatus, for example a personal computer. Typically computing apparatus has a processor associated with memory (ROM and/or RAM), a mass storage device such as a hard disk drive, a removable medium drive (RMD) for receiving a removable medium (RM) such as a floppy disk, CDROM, DVD or the like, input and output (I/O) control units for interfacing with the components of the monitoring facility of FIG. 5 to enable the processor to control operation of these components. The user interface consists, for example, of a keyboard, a pointing device, a display such as a CRT or LCD display and a printer. The computing apparatus may also include a communications interface such as a modem or network card that enables the computing apparatus to communicate with other computing apparatus over a network such as a local area network (LAN), wide area network (WAN), an Intranet or the Internet. The processor may be programmed to provide the logic features of the examples described herein by any one or more of the following ways: 1) by pre-installing program instructions and any associated data in a non-volatile portion of the memory or on the mass storage device; 2) by downloading program instructions and any associated data from a removable medium received within the removable medium drive; 3) by downloading program instructions and any associated data as a signal supplied from another computing apparatus via the communications interface; and 4) by user input via the user interface.

### Asset Monitoring System Example

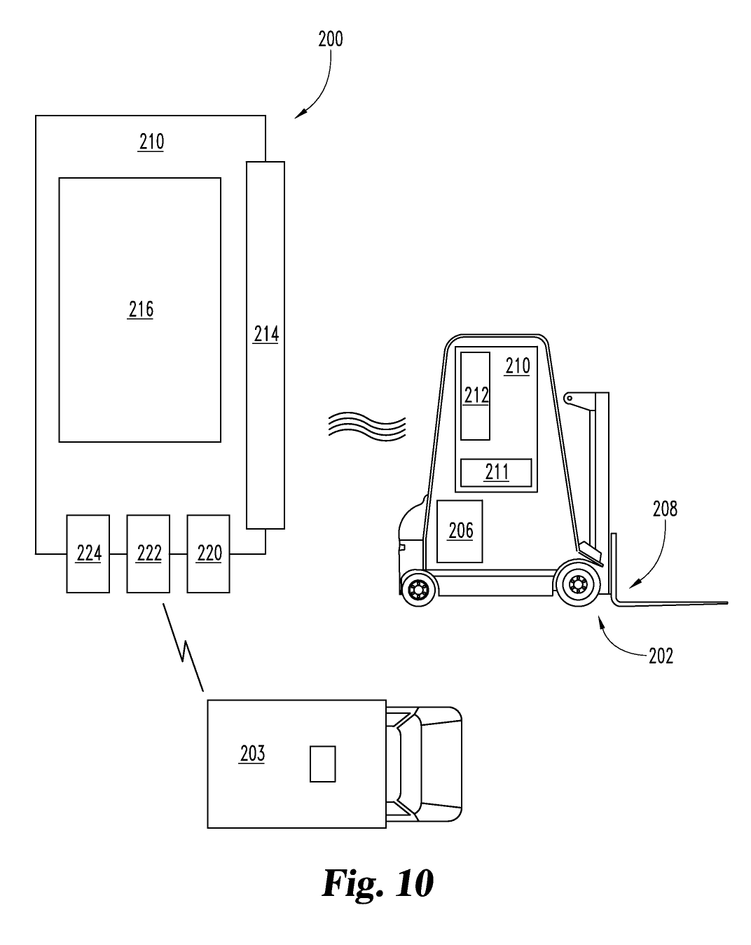

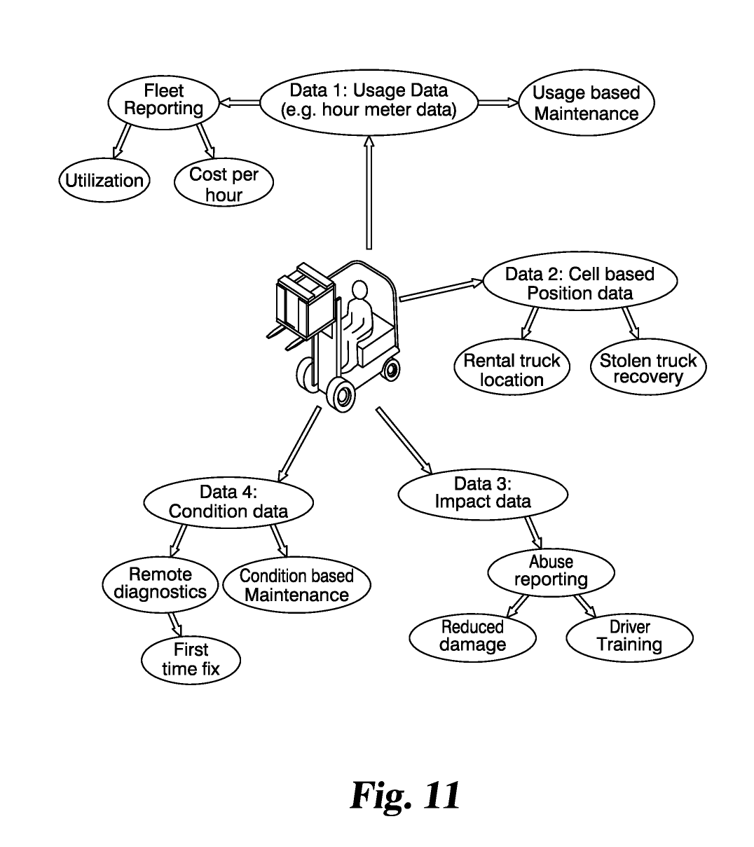

In FIGS. 10 and 11 an asset monitoring system is shown generally at 200. The asset monitoring system comprises a plurality of vehicle assets 202 including vehicles of for lifting and carrying goods around a site such as a warehouse, building site or the like, and a remote monitoring system 204 comprising a remote monitoring station for monitoring the vehicles. The asset monitoring system 200 also includes maintenance vehicles 203 for carrying maintenance equipment (including spare parts) and maintenance personnel to the sites where the vehicles are located.

Each vehicle asset 202 includes an engine or electric motor 206 for providing the motive force required to drive movement of the vehicle assets and a hydraulic or other such system 208 for generating the force required to lift loads.

The vehicle assets also comprise a monitoring and reporting device 210, which is similar to the authorization control unit 1 of FIG. 1 and the control unit 35 of FIG. 4 and which may include similar or identical features and functionality.

The monitoring and reporting device 210 comprises a measurement interface 211, such as the CAN vehicle bus described above, that can obtain operational parameters for each vehicle asset 202, including usage, condition and impact related operational parameters. The monitoring and reporting device 210 also comprises a communication interface 212, which may be similar to the communication interface 38 shown in FIG. 4, via which the operational parameters can be communicated to the remote monitoring station 204.

The usage parameters include parameters representing the load lifted by the vehicle asset 202 (e.g. the total weight of vehicle, the force applied to lift the load, the height a load is lifted from/to, hydraulic pressure, a signal obtained from a force transducer, tire pressure, hydraulic pump operation parameters, and any other parameter indicative of load, or work done to lift a load). The usage parameters also include parameters representing the usage of the vehicle asset 202 (e.g. distance moved, maximum and/or average vehicle speeds reached, and/or traction force applied to move the vehicle) per unit/time. The usage parameters may also include other parameters indicating how the vehicle is used such as parameters indicating the vehicle is being used to tow, the presence or absence of a driver in the driver's seat.

The condition related parameters may, for example, include parameters indicative of: fault onset; critical component temperatures; wear levels for brakes and/or other critical components; oil pressure and/or temperature; tire pressure; fuel level/consumption; brake fluid levels and/or pressures; coolant temperatures; battery charge levels; etc.

The impact parameters may, for example, comprise tilt and/or acceleration parameters as described previously.

It will be appreciated that there are a multitude of different possible usage/impact/condition parameters only a few of which are mentioned by way of example. Furthermore, there may be overlap between the different types (usage/impact/condition) of parameters, for example with condition and/or usage related parameters serving as impact related operational parameters.

The remote monitoring station 204 comprises a communication interface 214 for receiving the operational parameters communicated by the communication interface 212 of the device 210, and a processor 216, which comprises analysis logic for analysing the received operational parameters, and for initiating an appropriate action based on the analysis.

The action initiated typically comprises generation of a report and/or a recommendation based on the analysis. For example:
a recommendation to purchase a vehicle of a recommended specification and/or type, for example, if current vehicle assets are over-used or are being used for tasks for which they are not ideally suited;
a recommendation to replace a vehicle asset with another vehicle either of the same type or of a different recommended specification and/or type, for example, if the vehicle to be replaced is being used for tasks for which they are not ideally suited or is about to suffer a catastrophic failure;
a recommendation for vehicle operator training/retraining, for example, if a particular driver, or group of drivers, is determined to be using the vehicle in an unsafe, abusive, or inefficient manner;
a recommendation for specified vehicle maintenance, for example where condition based operational parameters indicate a fault has or is about to develop;
a recommendation to modify vehicle usage in a specified way, for example to improve efficiency;
a maintenance report identifying historic and/or predicted future vehicle maintenance requirements over time;
a cost of ownership report identifying historic and/or estimated future vehicle cost of ownership over time;
an incident report identifying the nature of the incident and the driver responsible, for example in the event of apparent unsafe usage, an identified impact, and/or usage which causes or accelerates the need for maintenance;
a usage report identifying historic and/or predicted future vehicle usage over time.

The remote monitoring station further comprises: a vehicle management interface 220 for allowing a fleet operator to access relevant reports/recommendations generated by the processor logic; a maintenance interface 222 a technician/engineer to access maintenance reports; and a control interface 224 for allowing a skilled technicians/engineer access to the measurement interface 211 of the monitoring and reporting device 210 directly.

The maintenance and control interface may, for example, comprise a dedicated graphical user interface at the remote monitoring station or may be a graphical user interface that can be accessed remotely, for example, via the internet or intranet or via other wireless or wired communications. The vehicle management interface may, for example, be a dedicated graphical user interface that can be accessed remotely, for example, at a facility of the fleet operator (which may be at the site where the vehicle assets are located or another location) via the internet or intranet or via other wireless or wired communications.

Thus, the control interface and processor logic together allow a user to access the measurement interface 211 remotely to obtain the operational parameters and to allow the user to interrogate the measurement interface 211 for diagnostic purposes from a remote location.

In one example, the operational parameters analysed by the monitoring and reporting device 210 comprise at least one usage parameter that represents geographical usage of a vehicle asset. In this example, the processor logic analyses the geographical usage to identify relevant usage patterns, for example, a vehicle's use in specific restricted areas, the routes taken by a vehicle between different locations, the average distances traveled between lifting a load and releasing it, etc. The processor logic then generates an appropriate report/recommendation based on the identified geographical usage patterns, for example to improve driver training, to modify site layout. The recommendation may, for example, comprise a recommendation to modify vehicle usage in a specified way to optimise the relative usage of different vehicles for different tasks, to improve overall fleet usage, and to streamline the movement of an individual vehicle asset or group of assets around a site.

In a related example, the processor logic analyses the geographical usage to identify usage patterns indicative of theft of a vehicle, and initiates a disable action (or an action to restrict the speed of the vehicle) if such a pattern is identified. Similarly, geographical usage is analysed to track the location of vehicle assets (e.g. assets rented to a third party), and alerts and/or disable/restriction actions are generated if the usage pattern indicates unexpected usage, or usage outside the terms of a rental contract.

In another related example, the processor logic analyses the geographical usage to allow enforcement of different vehicle speed limits in different zones of the site in which the vehicles operate. In this example, the processor logic is adapted to determine a speed limit based on a zone in which the vehicle is located (or approaching) and to impose the speed limit by sending commands, via the communication interface, to the vehicle to limit its maximum speed appropriately. It will be appreciated that other zone based restrictions (such as load restrictions and or lift height restrictions) may be enforced in a similar manner.

The geographical position information may be derived from positional information derived in accordance with the system described with reference to FIG. 9 and/or cell tower triangulation position information (especially where the vehicle assets are used outdoors rather than in a warehouse environment).

In another example, the processor logic of the remote monitoring station is provided with access to a database of financial information related to usage/maintenance of the vehicle assets. This financial information comprises data from which allows calculation or at least estimation of: the costs of historic and/or future ownership; the residual values for a vehicle at a point in time; costs of required maintenance actions; old vehicle replacement/new vehicle acquisition; etc. The financial data will typically include, for example, depreciation data/algorithms, new vehicle pricing data/algorithms, maintenance pricing data/algorithms, any contract penalties for exceeding certain usage thresholds (e.g. cumulative/average weight lifted, distance traveled, and/or a combined weight/distance threshold). Accordingly, the processor logic is adapted to generate recommendation/reports based on the financial information, for example:
a recommendation to purchase a vehicle of a recommended specification and/or type, for example, if the purchase is determined to be cost-effective when the cost of continued use of the current vehicle assets is taken into account;
a recommendation to replace a vehicle asset for example, if the replacement is determined to be cost-effective given the maintenance or other costs of continued use of the vehicle asset to be replaced and/or its residual value, and or is taken into account;
a recommendation for vehicle operator training/retraining, for example, if such training is determined to offer benefits in terms of reduced cost of ownership through efficiency savings arising from improved utilisation;
a recommendation for specified ‘just-in-time’ vehicle maintenance, for example where the maintenance is determined to be cost-effective when compared to the costs of continued use, the risks of potential component failure and associated downtime costs, and/or the impact on residual asset value of a catastrophic or other serious failure;
a recommendation to modify vehicle usage in a specified way, for example to improve cost-efficiency, or to avoid, reduce or otherwise limit financial penalties for exceeding usage thresholds (referred to herein as ‘contract overages’);
a cost of ownership report identifying historic and/or estimated future vehicle cost of ownership over time;
an incident report identifying the nature of the incident and the driver responsible, for example in the event of apparent unsafe usage, an identified impact, and/or usage which causes or accelerates the need for maintenance;

Thus, if a residual value of the vehicle is less than the cost of the required maintenance, or projected maintenance, requirements for a specific maintenance period (say three, six, nine, twelve months or longer) then a recommendation to replace the vehicle could be generated, thereby allowing the residual value of the vehicle to be recovered. A similar recommendation could be made if a catastrophic or serious failure is considered to be imminent, thereby allowing the residual value of the vehicle to be recovered prior to failure.

Similarly, if the loads typically being lifted by the vehicle exceed an optimum load range for energy efficient operation, vehicle reliability and/or vehicle longevity then a recommendation might be generated either to replace the vehicle with one having a higher optimum load maximum or to acquire such a vehicle in addition to those in the current fleet. Alternatively or additionally, a recommendation might be generated to modify vehicle usage in a specified way to improve the reliability, longevity, energy efficiency, or cost effectiveness of the vehicle. This is particularly advantageous where, for example, analysis of a vehicle's condition indicates that it may suffer a fault (possibly a catastrophic fault) within a certain time period (say one, two, three, six, nine, twelve months or longer) and modifying the vehicle's usage could prolong the vehicle's life before maintenance is required.

In another example, the processor logic of the remote monitoring station is adapted to determine a maintenance requirement for a vehicle asset 202, based on analysis of condition based operational parameters, and to initiate generation of a maintenance report comprising instructions for specified vehicle maintenance. The processor logic provides the maintenance report, in operation, to the maintenance interface 222 for access via a communication device of a maintenance vehicle 203, by maintenance personnel such as a technician/engineer.

In this example, the processor logic is also adapted to initiate generation of a maintenance report comprising details of the equipment and/or spare parts required for the technician/engineer to carry out the maintenance instructions. The maintenance report, including details of the equipment and/or spare parts, is provided to a communication device located at a maintenance depot, via the maintenance interface 222, for review by staff at the maintenance depot. Accordingly, the staff at the depot can load a maintenance vehicle scheduled for use when carrying out the maintenance instructions with the equipment and/or spare parts required.

It will be appreciated that rather than separate reports, a single maintenance report may be generated, which includes the maintenance instructions and details of the equipment and/or spare parts, and provided for access both at the depot and from the maintenance vehicle.

In another example, the processor logic of the remote monitoring station is adapted to determine if the measured operational parameters indicate an undesirable situation (for example, damage/further damage to the vehicle) may be caused if preventative action is not taken. This analysis may be based on usage parameters, for example, parameters indicating potentially damaging use of the vehicle (e.g. an attempt to lift over-weight loads or to travel over a recommended speed for a load). The analysis may be based on condition parameters, for example, parameters indicating the onset of a potentially damaging fault which current use of the vehicle may exacerbate (e.g. low tire pressure, break wear above a threshold or the like). The analysis may be based on impact parameters, for example, parameters indicating a potentially damaging impact has occurred the potential affects of which may be exacerbated by further unrestricted use of the vehicle. In response to this analysis the processor logic is adapted to determine if a damage limitation procedure is necessary and, if so, to initiate a limitation action (e.g. a damage limitation action). The limitation action typically comprises communication of a limitation message (e.g. a damage limitation message) to a vehicle asset 202 which limitation message comprises, a command (or set of commands) which will cause the vehicle to automatically restrict operation of the at least one vehicle asset (for example, to limit potential damage). Alternatively or additionally, the limitation action may comprise communication of a limitation message to a vehicle asset 202 which limitation message comprises a message (and/or an alert command) for providing an audible, visual or other alert to a vehicle operator to warn of the need to restrict operation of the vehicle asset, and to inform the operator of what restriction action is required.

The restriction action initiated by the processor logic may comprise any suitable action but typically comprises restricting at least one of: maximum vehicle speed, maximum available lifting/motive power, maximum vehicle reach, and/or maximum engine revs (rpm), and or maximum vehicle speed for a given load. Of course, the restriction of operation of the at least one vehicle asset may simply comprise disabling some or all of the vehicle assets functionality (when it is deemed safe to do so).

In another example, the processor logic of the remote monitoring station is adapted to monitor the work level of the vehicle by monitoring and analysis of load lifting usage and other related usage of the vehicle asset over time. For example, cumulative/average weight lifted and cumulative/average height the weight is lifted through may be monitored/analysed for assessing load lifting usage, and cumulative/average distance traveled and/or cumulative/average traction force applied may be monitored/analysed for assessing engine related usage. Accordingly, both lifting work (e.g. ‘power-by-the-ton’) and other work (e.g. ‘power-by-the-hour’) may be determined. This not only allows maintenance actions to be planned and scheduled appropriately, but also allows pricing structures based on actual usage to be used. This has benefits for fleet operators in terms of reduced cost when business is slow, and for vehicle and maintenance providers in terms of pricing structures which better reflects depreciation of the vehicle assets with use, and in terms of more efficient utilisation of maintenance personnel.

In another example, the processor logic of the remote monitoring station is adapted to store regular snapshots of a predetermined set of condition, usage, and/or impact related operational parameters for each vehicle asset, each snapshot comprising a record of the stored operational parameters as measured at an associated time. This allows a user (or the process logic) to compare ‘before’ and ‘after’ snapshots manually (or automatically) for a particular vehicle asset, or to compare snapshots stored for different vehicles of the same type, thereby improving diagnostic capability. For example, a comparison of snapshots before and after a fault occurs may help diagnosis of the cause of the fault, or at least allow a vehicle to be returned to a previous known ‘healthy’ state. Similarly, a comparison of snapshots for a ‘healthy’ vehicle with a faulty vehicle may also help diagnosis of the cause of the fault. The snapshots are accessible via a technician interface which may comprise the maintenance interface 222, or part of it.

In another example, the processor logic of the remote monitoring station is adapted to adapted to or predict the onset of a failure (e.g. a catastrophic failure) from the received operational parameters, and to initiate an action based on the parameter analysis. The action typically comprises an action to restrict use of the vehicle (as described previously) by disabling or otherwise limiting operation of some or all functionality of the vehicle. The action may comprise the generation of a report comprising a recommendation to replace the vehicle or for urgent maintenance action.

### Asset Monitoring System

### Other Beneficial Features

Other event categories, possible actions, and benefits of the asset monitoring system are summarised in Table 1. For each event category, where appropriate, operational parameters are measured and communicated via the communication interface. For example for tire/oil pressure monitoring the measured operational parameters will comprise tire/oil pressure indicators measured by associated sensors. Similarly, for emission monitoring, the measured operational parameters will comprise emission measurements taken, for example, by exhaust gas sensors for a vehicle asset.

TABLE 1

| Event Category | Consideration | Action/Detail |
|---|---|---|
| Maintenance reminder | Reduce emergency | Notify prior to due via display, When due |
| | breakdowns and prolong | sound alarm and slow equipment down, |
| | equipment life | Communicate to server |
| Low oil pressure | Prevent engine from | Notify operator, Shut unit off, |
| | premature wear and | Communicate to server |
| | possibly locking up | |
| Tire pressure monitoring | Increase tire life and | Notify Operator, Schedule tire |
| | minimizing cost, | inspection, Communicate to server |
| | Maintains safety for | |
| | lifting | |
| Emissions monitoring | Keep emissions at | Notify Operator, Schedule inspection, |
| | required levels | Communicate to server |
| Major component | Reduces excessive wear | Notify operator, Shut unit off, |
| temperatures | prolonging component | Communicate to server |
| | life | |
| Battery monitoring | Optimizing battery | Notify operator, Slow equipment down, |
| | charging practices, helps | Schedule charging, Communicate to |
| | extend electrical parts | server |
| | due to high amp draw | |
| Fuel monitoring | Track fuel usage | Notify operator of low fuel, Communicate |
| | | to server, Identify exceptions |
| GEO fencing | Keeping equipment in a | notify operator, Shut down truck, |
| | dedicated area | Communicate to server |
| Real time remote | Reduce expense and | Read equipment values, Make needed |
| diagnostics | improve first time fix | setting changes, |
| Impacting monitoring | Reduce damage and | Notify operator. Sound alarm, Shut down |
| | encourage better driving | equipment, Communicate to server |
| | practices | |
| Operator safety | Ensure operator follows | Detect seat belt not connected, Operator |
| monitoring | safety procedures | not in seat, Park brake not applied |
| Speed limiting | Control speeds based on | Setting speed thresholds, Adjust |
| | a threshold | equipment speed, Communicate to |
| | | server |
| Access control | Limit equipment usage | Control access, Communicate to server |
| | to authorized operators | |
| Equipment checklist | Record keeping for | Communicate to server |
| | compliance and possible | |
| | maintenance scheduling | |
| Lifting safety | Operate equipment at | Notify operator, Adjust equipment speed, |
| | correct operating | Communicate to server |
| | capacity | |
| Operational monitoring | Maximize productivity, | Communicate to server, Analyze data |
| | Utilization, Control | |
| | equipment cost per hour | |
| Dispatch optimization | Reduce fuel, travel, labor | Dispatch the appropriate technician. |
| | cost | |
| Workorder optimization | Time accountability and | Revenue accountability, Technician |
| | accurate record keeping | utilization and productivity, |
| Location tracking | Know real time location | Communicate to Server |
| | of asset | |
| Equipment availability | Real time status to | Communicate to server |
| status | improve customer | |
| | service | |
| Proximity sensing | Reduce accidents | Notify operator, Slow equipment down. |
| | | Communicate to server |
| Operator workflow | Optimizes workflow | Send the workflow to the operator to |
| scheduler | | schedule their. |
| Operator to Operator to | Improve operator | Allow two way real time communication |
| dispatch communication | efficiencies | |
| Convert signals to | Provide a single protocol | Retrofit many different types of |
| standard CANBUS | for all types of | equipment, Communicate to server. |
| protocol | equipment | |
| Remote equipment | Reduce labor cost and | Push software updates at scheduled |
| software updates | equipment downtime | times |
| Lift and speed based on | Reduce accidents and | Set threshold for each zone to control |
| zoning | damage | speed and lifting height |
| Tilt safety | Prevent equipment from | Set based on threshold and capacities |
| | turning over | |
| Auto CANBUS protocol | It recongizes the | Detect upon power up |
| detection | protocol without manual | |
| | user intervention | |

### Asset Monitoring System

### Summary

Accordingly, in summary the asset monitoring system described allows the use of vehicle telemetry data (e.g. data provided via the CANBUS interface) to assist in the pre-diagnosis of potential problems across an entire geographical area. Use of similar telemetry provided in the vans of engineers can be used to track their location/status.

Data identifying failures and diagnosed pending failures can be used in conjunction with usage data to generate maintenance plans, which schedule and prioritise maintenance work. In this way, technicians/engineers having the requisite skills can be dispatched to multiple sites efficiently. All the equipment and spare parts necessary for the maintenance requirements can be pre-loaded in the technician/engineer's maintenance vehicle in advance. Accordingly, unnecessary travel between the multiple sites (and associated traffic congestion) can be avoided by scheduling visits to geographically proximate sites on the same day to complete a maintenance job first time, just in time. Multiple site visits to diagnose and then fix a fault can also be avoided because most faults can be diagnosed remotely. Hence, the carbon footprint of the maintenance operation can be reduced, engineering/technician and other resources can be optimised, maintenance cost both to a fleet operators and maintenance providers can also be reduced, and truck downtime can be minimized.

Telemetry data may also be combined with impact data to help a customer such as a fleet operator plan driver training and other interventions to minimise damage (e.g. by identifying and reporting potential danger areas at a site, poor driver practice, etc).

The telemetry data may also be used to provide additional beneficial features for customers including: the ability to track vehicle usage (e.g. power by the hour and/or power by the ton); ‘just-in-time’ condition based maintenance instead of planned maintenance at predetermined maintenance intervals; reduced cost of ownership associated with reduced maintenance costs arising, for example, from ‘just-in-time’ maintenance; provision of replacement recommendations/reports in advance of equipment failure (e.g. catastrophic failure) allowing residual vehicle value to be recovered before the failure; provision of targeted maintenance recommendations and reports offering appropriate maintenance advice to fleet operators who choose to maintain their own vehicles; and the monitoring of ownership costs and the provision of associated reports based on actual usage and maintenance.

Fleet operators are beneficially provided with system facilities which allow them to capture and track all costs related to vehicle assets, to measure driver and asset productivity, etc. Furthermore, fleet operators are provided with appropriate reports and recommendations which assist them to optimise fleet usage including movement of vehicles around the site to maximise utilisation and minimise contract overages, to retire vehicles with impending major failures, and to optimise fleet composition to maximise efficiency, minimise energy consumption, and minimise maintenance and other costs.

Vehicle providers are beneficially able to use the telemetry data to locate and recover a truck in the case of theft and/or to restrict vehicle usage to allow recovery. Similarly, vehicle providers are beneficially able to keep track of rental fleet units locations. Furthermore vehicle and maintenance providers are provided with a ‘360 degree view’ of customer needs allowing them to give the correct advice on all issues surrounding a customer's fleet, and to optimise their maintenance activity to minimise travel and maximise customer service, including provision of the advice on fleet usage to minimise carbon footprint & costs.

The provision of a control interface advantageously allows a skilled engineer/technician to carry out remote diagnostics (for example, by interrogating the CANBUS to diagnose a fault and determine parts & skills requirements) before despatching a maintenance technician to repair a vehicle fault or carry out other appropriate vehicle maintenance actions such as servicing and/or preventative maintenance actions. Thus, the device on the telemetry device is effectively used as a router to give direct access to the vehicle CANBUS, thereby allowing the specialist engineer/technician remote access. Advantageously, this provides benefits in terms of reduced travel/carbon footprint/cost to client, etc. The before and after snapshots of vehicle condition data from CANBUS allows analysis of net change to further improve diagnostics.

It can be seen, therefore, that the generation of appropriate maintenance, replacement, acquisition, vehicle usage (and similar) recommendations based on condition, usage, impact or other status information received from the vehicles, has many potential benefits for a fleet operators, vehicle providers, maintenance providers, and the like.

The features of methods and devices set out herein relate to systems which can be used in conjunction with one another and are intended to be so combined where appropriate. For example an authorisation and control device according to exemplary aspect 1 or any of the exemplary aspects dependent thereon (with or without all of the recited features of those exemplary aspects) may include some or all of the features of a programmable vehicle controller as set out in exemplary aspect 76 and the exemplary aspects dependent thereon. Such combinations are examples from which it will be apparent that the features of any example, aspect or embodiment described herein may be combined with some or all of the features of any other embodiment aspect or example. In addition certain terminology used throughout the description should not be construed as limiting for example where reference is made to a vehicle or a truck this may be any mobile asset having the required features and functionality. Equivalently sensors and detectors may be referred to interchangeably as indicated by the context of the description. Such terms are to be read in context and interpreted in light of the rest of the description. It is apparent that many modifications and variations of the present invention are possible in light of the above teachings. References to specific values or standards are by way of example only. It is therefore to be understood that, within the scope of the appended exemplary aspects and claims the invention may be practiced otherwise than as specifically described.

### Exemplary Aspects

Further exemplary aspects are set out in the following numbered clauses:

1. An authorisation control device for one of a plurality of fleet vehicles, the authorisation control device for selectively enabling operation of a vehicle on which it is installed comprising vehicle identity logic for storing or reading a vehicle identifier for the vehicle on which the authorisation control device is installed and a communication interface for communicating with a removable rewritable driver token storing a unique driver identifier and a list of a plurality of authorised vehicle identifiers denoting vehicles which the driver is authorised to drive, the authorisation control device including driver record logic for storing or communicating the unique driver identifier and enable logic for generating an enable signal for the vehicle based on matching the vehicle identifier for the vehicle on which the authorisation control device is installed with one of the vehicle identifiers in the list of authorised vehicles stored in the token.

2. The authorisation control device of aspect 1 configured to obtain and record a unique driver identifier.

3. The authorisation control device of aspect 2 having a second communication interface and being further configured to communicate the unique driver identifier over a the second communication interface to a remote device.

4. The authorisation control device of aspect 1 configured to determine whether a vehicle identifier matches a vehicle identifier stored on the driver token.

5. The authorisation control device of aspect 1 configured to communicate wirelessly with the removable rewritable driver token.

6. The authorisation control device of aspect 5 wherein the device is configured to communicate wirelessly using an RFID-type protocol.

7. The authorisation control device of aspect 5 wherein the authorisation control device is arranged to supply power inductively to the removable rewritable driver token.

8. The authorisation control device of aspect 7 configured to verify that the removable rewritable token remains in communication with the device while the vehicle is being operated.

9. The authorisation control device of aspect 8 configured to enable for a preset time following matching the vehicle identifier for the vehicle on which the authorisation control device is installed with one of the vehicle identifiers in the list of authorised vehicles stored in the token.

10. The authorisation device of aspect 1 further arranged to download the list of authorised vehicle identifiers and to determine whether at least one of the plurality of vehicle identifiers matches the vehicle identifier for the vehicle on which the authorisation control device is installed.

11. The authorisation device of aspect 1 further arranged to download each identifier of the list of authorised vehicle identifiers sequentially and to discontinue downloading in the event that a downloaded identifier matches the vehicle identifier for the vehicle on which the authorisation control device is installed.

12 The authorisation device of aspect 1, wherein the removable rewritable driver token is a smart token and wherein the device is configured to communicate the vehicle identifier to the token and wherein the token is configured to provide a response to indicate whether the communicated vehicle identifier matches one of the list of authorised vehicle identifiers stored on the smart token.

13. A removable rewritable driver token having a communicator for communicating with a vehicle authorisation device, the token storing a unique driver identifier and a list of a plurality of authorised vehicle identifiers denoting vehicles which the driver is authorised to drive.

14. The removable rewritable driver token of aspect 13 capable of communicating with a secure authorisation device and capable of storing at least 20 vehicle identifiers and a driver identifier.

15. The removable rewritable driver token of aspect 13 storing at least 1 kilobyte of data.

16. The removable rewritable driver token of aspect 15 wherein the driver identifier and each vehicle identifier of the list of vehicle identifiers are globally unique.

17. The removable rewritable driver token of aspect 13 wherein each driver identifier and each vehicle identifier of the list of a plurality of authorised vehicle identifiers comprises at least 32 bits of data.

18. The removable rewritable driver token of aspect 13 wherein the token is arranged to store additional driver data not required to be downloaded for vehicle authorisation

19. The removable rewritable driver token of aspect 13 wherein the token is arranged to communicate at a data transfer rate of at least 5 kilobit/s, more preferably at least 10 kilobit/s.

20. The removable rewritable driver token of aspect 13 wherein the token may also serve as an ID card with visible text and/or a photo ID on the exterior.

21. The removable rewritable driver token of aspect 13 wherein the token may store data for use by an application other than vehicle authorisation.

22. A system comprising at least one authorisation control device according to aspect 1 and further comprising an access point, provided separately from the vehicle or vehicles to be authorised, to which a driver may present a token the access point including reader circuitry for reading the token to recognise a unique identifier of the token and writing logic for updating the list of authorised vehicles stored on the token.

23. The system of aspect 22 wherein the access point is a component of a facility access control system.

24. The system of aspect 23 arranged such that, to gain access to the facility, a driver may present a token to the access point.

25. The system of aspect 24 comprising a controller and a set of driver vehicle permissions and wherein the set of driver vehicle permissions may be updated to enable an updated list to be updated at next presenting of the token.

26. The system of aspect 24 wherein the access point is arranged to communicate with the token to instruct deletion or addition of individual entries.

27. A method of controlling access to a set of assets by an operator comprising: reading a machine-readable re-writable token storing a unique identifier of the operator and a list of assets for which the operator is authorised to obtain the unique operator identifier; checking whether updates for the set of assets for which the operator is authorised are stored; in the event that updates are stored, writing to the token to update the stored list of assets.

28. The method of aspect 27 comprising signalling that the token may be removed after writing is completed.

29. The method of aspect 28 wherein signalling comprises an audible signal such as a beep and/or a visual signal such as a light.

30. The method of aspect 27 comprising physically retaining the token during writing and releasing the token after writing.

31. The method of aspect 27 wherein communication with the token for both reading and writing is conducted wirelessly

32. The method of aspect 31 wherein the wireless communication is conducted over a range of at least 5 cm, preferably at least 10 cm.

33. The method of aspect 31 wherein the wireless communication is conducted at a data transfer rate such that updating is completed in less than 5 seconds, preferably less than 2 seconds.

34. The method of aspect 27 comprising signalling an error, for example with an audible tone in the event that updating is not completed before the token is removed.

35. A fleet of vehicles comprising a plurality of vehicles wherein each vehicle is provided with an authorisation control device according to aspect 1 wherein each authorisation control device is configured with a unique vehicle identifier.

36. A method of scheduling maintenance of a plurality of assets at a respective asset location, the method comprising: receiving respective asset operational parameters from the plurality of assets at a remote monitoring system; receiving respective asset identifiers, obtaining position information and determining a likely maintenance requirement for at least one asset based on the operational parameters; and scheduling maintenance actions for one of the plurality of assets based on a maintenance requirement of at least one other asset of the plurality of assets and the position information.

37. A method according to aspect 36 wherein a likely maintenance requirement includes a repair of an asset.

38. A method according to aspect 36 wherein a likely maintenance requirement includes preventive maintenance of an asset.

39. A method according to aspect 36 wherein a likely maintenance requirement includes preventive maintenance of an asset to prevent a predicted component failure.

40. A method according to aspect 36 wherein an asset is a warehouse vehicle and wherein the respective asset location is a warehouse.

41. A method according to aspect 36 wherein the operational parameters are received via a wireless communication link and wherein position information is obtained by inferring position information from a property of the communication link.

42. A method according to aspect 41 wherein the property of the communication link comprises at least one of: an IP address, a GSM number, an email address and wherein inferring includes making a comparison with stored location information associated with that communication link.

43. A method according to aspect 42 wherein the operational parameters comprise CANBUS information derived from a CANBUS of the vehicle.

44. A method according to aspect 43 wherein CANBUS information includes at least one of hydraulic pressure, oil pressure and temperature, lift time, move time, vehicle speed, brake operation, brake fluid levels and pressures, coolant temperature, battery charge levels.

45. A monitoring and reporting device for use in a mobile asset comprising: a measurement interface for measuring operational parameters of a mobile asset and a buffer coupled to the measurement interface for storing measured operational parameters; and a communication interface for receiving commands from a remote monitoring system and a processor configured to store measured operational parameters in the buffer in response to a received command.

46. A monitoring device according to aspect 45 wherein the measurement interface includes a CANBUS interface.

47. A monitoring device according to aspect 46 wherein operational parameters include parameters derived from a CANBUS message and wherein the processor is configurable by a remote command to store selected CANBUS messages for storage.

48. A monitoring device according to aspect 47 wherein CANBUS messages are selected based on a message type identifier.

49. A monitoring device according to aspect 45 wherein the processor is configured to transmit the contents of the buffer using the communication interface before the buffer is full.

50. A monitoring device according to aspect 45 wherein the processor is configured to determine whether the communication interface is able to communicate with a remote monitoring station.

51. A monitoring device according to aspect 50 wherein the processor is configured to store data from the buffer into a non-volatile memory in the event that it is determined that the communication interface is not able to communicate with a remote monitoring station.

52. A monitoring device according to aspect 50 wherein the processor is configured to test periodically whether the communication interface is able to communicate with a remote monitoring station.

53. A monitoring device according to aspect 50 wherein the processor is coupled to a user actuable switch and is configured to test whether the communication interface is able to communicate with a remote monitoring station in response to actuation of the switch.

54. A monitoring device according to aspect 50 wherein, the processor is configured to transmit stored data in the event that it is determined that the communication interface is able to communicate with a remote monitoring station.

58. A monitoring station comprising: a communication interface for communication with a plurality of monitoring devices each device arranged to monitor an operational parameter of a mobile asset; and, a processor coupled to the communication interface to receive a first operational parameter associated with a first asset and a second operational parameter associated with a second asset; wherein the processor is configured to determine a maintenance requirement of the first asset based on the first operational parameter; and to select a maintenance action for the second asset based on the maintenance requirement of the first asset and the second operational parameter.

59. A monitoring station according to aspect 58 comprising a memory for storing a list of identifiers, each identifier associated with a monitoring device.

60. A monitoring station according to aspect 59 wherein each identifier indicates a type of asset.

61. A monitoring station according to aspect 58 having a memory for storing a spare parts inventory and wherein the processor is arranged to read the spare parts inventory and to select a maintenance action for the second asset based on an availability of spare parts.

62. A monitoring station according to aspect 61 wherein the processor is arranged to indicate a requirement for additional spare parts in response to determining a maintenance requirement.

63. An interface device for a vehicle having a control bus over which vehicle parameters are passed comprising a vehicle interface for communicating with a control bus of the vehicle; a wireless interface for communicating data packets with a remote server; buffer memory for storing packets to send over the wireless interface; and a processor for controlling communication, wherein the processor is arranged to detect whether wireless interface is available for live transmission to the server and to select information for transmission or buffering based on availability.

64. An interface device according to aspect 63 having further memory for storing information separate from the buffer, wherein the processor is arranged to respond to a query received over the interface to transmit information stored in the further memory on request.

65. Apparatus according to aspect 63 further comprising an operator communication interface arranged to store operator input received when the interface is not available for transmission at a time the wireless interface is available.

66. Apparatus according to aspect 63 wherein the wireless interface is a telecommunications interface having a data transmission protocol and a text message protocol wherein the apparatus is arranged to format data into messages suitable for transmission by the text message protocol in the event the data transmission protocol is unavailable.

67. An interface device according to aspect 65 wherein the processor is arranged to communicate operator information bi-directionally with an operator console or operator application.

68. A server for communicating with a plurality of remote vehicles each having an interface device according to aspect 67 comprising vehicle data memory for storing vehicle information received from a plurality of vehicles and operator information memory for storing operator information received or messages for transmission to the operator.

69. A server according to aspect 68 arranged to make the vehicle data memory available to a first application and the operator information memory available to a second application.

70. A method of operating a control bus over which vehicle parameters are passed, the method comprising communicating with a control bus of the vehicle using a vehicle interface; and communicating data packets with a remote server over a wireless interface; storing packets to send over the wireless interface in a buffer memory; and detecting whether a wireless interface is available for live transmission to the server and selecting information for transmission or buffering based on availability of the wireless interface.

71. The method of aspect 70 further comprising storing information in a further memory separate from the buffer, and responding to a query received over the interface to transmit information stored in the further memory on request.

72. The method of aspect 70 further comprising storing operator input received when the wireless interface is not available for transmission at a time the wireless interface is available.

73. The method of aspect 70 wherein the wireless interface is a telecommunications interface having a data transmission protocol and a text message protocol, the method comprising formatting data into messages suitable for transmission by the text message protocol in the event the data transmission protocol is unavailable.

74. The method of aspect 70 further comprising communicating operator information bi-directionally with an operator console or operator application.

75. The method of aspect 74 further comprising verifying operator information based on information read from a removable rewritable token.

76. A programmable vehicle power controller comprising a wireless communication interface, and a vehicle inactivity detector for detecting inactivity affecting a component of a vehicle and a shutdown controller coupled to shut down at least the component of the vehicle and arranged to receive over the wireless communication interface a command to set an inactivity time interval based on the received command and to shut down the component following inactivity for the time interval.

77. A programmable vehicle controller according to aspect 76 wherein the shut down controller is further configured to shut down the vehicle in response to a received shut down command.

78. A programmable vehicle controller according to aspect 76 wherein the vehicle inactivity detector is coupled to a CANBUS of the vehicle to detect inactivity of a vehicle component.

79. A programmable vehicle controller according to aspect 78 wherein the component is an engine of the vehicle.

80. A programmable vehicle controller according to aspect 76 wherein the vehicle power controller is partly or wholly integrated with an authorisation control unit as set out in aspect 1.

81. A programmable vehicle controller according to aspect 76 arranged to set a time interval based on a received command and vehicle operator information

82. A programmable vehicle controller according to aspect 81 wherein vehicle operator information is derived from an authorisation control device according to aspect 1.

83. A programmable vehicle controller according to aspect 81 wherein vehicle operator information is derived from a removable reprogrammable token.

84. A programmable vehicle controller according to aspect 81 wherein the vehicle power controller is configured to set the time interval based on a time of day and vehicle operator information comprising timing information.

85. A positioning system for determining the location of a mobile asset in a facility, the system comprising: a plurality of machine readable identifiers positioned about the facility; and a memory storing an association between one or more positions in the facility and one or each of the plurality of identifiers; and a mobile asset having a proximity reader for reading a machine readable identifier of the plurality of machine readable identifiers in a reading range of the reader; and a processor, in communication with the reader and the processor arranged to determine a position of the mobile asset based on the stored association.

86. A positioning system according to aspect 85 wherein the mobile asset comprises logic for comparing an identifier with a stored association to determine a position of the mobile asset based on the stored association.

87. A positioning system according to aspect 85 wherein the machine readable identifiers are positioned with a separation of at least five times the reading range of the reader.

88. A warehouse vehicle comprising a proximity reader for reading a machine readable identifier; and a memory storing an association between each of a plurality of identifiers and one or more positions; and comparison logic arranged to compare an identifier with a stored association to determine a position.

89. A warehouse vehicle according to aspect 88 wherein the comparison logic is configured to compare an identifier with a stored association in response to the proximity reader reading a machine readable identifier.

90. A warehouse vehicle according to aspect 88 wherein the proximity reader is a near field RF communicator.

91. A warehouse comprising a plurality of machine readable markers each marker associated with a location; and one or more warehouse vehicles comprising a proximity reader for reading the machine readable markers; and comparison logic for comparing information read from the markers with a stored association to determine a location of the vehicle.

92. A server for communicating with a plurality of remote vehicles each having an interface device according to aspect 67 comprising vehicle data memory for storing vehicle information received from a plurality of vehicles and operator information memory for storing operator information received or messages for transmission to the operator.

93. A server for communicating with a plurality of vehicles, each vehicle associated with a vehicle identifier, having a processor coupled to a memory comprising instructions for determining inactivity timeouts based on at least one of: time of day, workload, historical data, location, and operator input; and to communicate determined time outs to selected vehicles

94. A server according to aspect 92 or 93 arranged to make the vehicle data memory available to a first application and the operator information memory available to a second application.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A vehicle asset monitoring system comprising:
at least one vehicle asset capable of lifting and carrying loads; and
a remote monitoring station capable of monitoring the at least one vehicle asset;
the vehicle asset comprising:
a motive unit for generating a motive force to move the vehicle asset;
a lift unit for generating a force to lift a load;
a measurement interface adapted to obtain a plurality of operational parameters for said vehicle asset, the operational parameters including:
i) at least one operational parameter influenced by a load lifted by the vehicle asset; and
ii) at least one other operational parameter related to usage of the vehicle asset; and
a vehicle-side communication interface adapted to communicate said obtained operational parameters to the remote monitoring station; and
the remote monitoring station comprising:
a station-side communication interface adapted to receive said operational parameters from said vehicle-side communication interface of the at least one vehicle asset; and
a processor adapted to analyse said received operational parameters, and to initiate an action based on said analysis.

2. A vehicle asset monitoring system as claimed in claim 1 further comprising at least one maintenance vehicle; wherein:
the remote monitoring station further comprises a report generator for generating a maintenance report comprising at least one maintenance instruction for said at least one vehicle;
and a maintenance interface adapted to provide said maintenance report for access by an operator of said maintenance vehicle.

3. A monitoring and reporting device for use in a vehicle asset comprising:
a measurement interface adapted to obtain a plurality of operational parameters for said vehicle asset, the operational parameters including:
i) at least one operational parameter affected by a load lifted by the vehicle asset; and
ii) at least one other operational parameter related to usage of the vehicle asset; and
a communication interface adapted to communicate said obtained operational parameters to a remote monitoring system.

4. A monitoring and reporting device as claimed in claim 3 wherein the at least one other operational parameter related to usage of the vehicle asset comprises a parameter representing the applied motive force.

5. A monitoring and reporting device as claimed in claim 3 wherein the at least one other operational parameter related to usage of the at least one vehicle asset comprises a distance moved by the vehicle asset.

6. A monitoring and reporting device as claimed in claim 3 wherein the at least one operational parameter affected by a load lifted by the at least one vehicle asset the comprises the force applied to lift the load.

7. A monitoring and reporting device as claimed in claim 3 further comprising a vehicle restriction unit for restricting operation of the at least one vehicle asset in dependence on contents of a message received via the communication interface.

8. A monitoring and reporting device as claimed in claim 7 wherein said restriction of operation of the at least one vehicle asset comprises restricting at least one of: speed, maximum available lifting/motive power, and/or maximum engine revolutions per minute.

9. A monitoring and reporting device as claimed in claim 7 wherein said restriction of operation of the at least one vehicle asset comprises disabling said at least one vehicle asset.

10. A monitoring and reporting device as claimed in claim 7 wherein said communication interface is adapted to receive a damage limitation message from said remote monitoring station, and wherein the vehicle restriction unit is adapted to restrict operation of the at least one vehicle asset in dependence on the contents of said damage limitation message.

11. A monitoring and reporting device as claimed in claim 3 further comprising an alert unit for generating an alert in dependence on contents of a message received via the communication interface.

12. A vehicle for lifting and carrying loads, the vehicle comprising:
a motive unit for generating a motive force to move the vehicle;
a lift unit for generating a force to lift a load;
a measurement interface adapted to obtain a plurality of operational parameters for said vehicle, the operational parameters including:
i) at least one operational parameter affected by a load lifted by the vehicle; and
ii) at least one other operational parameter related to usage of the vehicle asset; and
a communication interface adapted to communicate said operational parameters to a remote monitoring system.

13. A remote monitoring station capable of monitoring at least one vehicle asset according to claim 12, the remote monitoring station comprising:
a communication interface adapted to receive operational parameters from at least one vehicle asset, the operational parameters including:
i) at least one operational parameter affected by a load lifted by the at least one vehicle asset; and
ii) at least one other operational parameter related to usage of the at least one vehicle asset; and
a processor adapted to analyse said received operational parameters, and to initiate an action based on said analysis.

14. A remote monitoring station as claimed in claim 13 wherein said received operational parameters comprise at least one condition/usage/impact parameter representing a condition/usage/impact of the at least one vehicle asset, and wherein said processor is adapted to analyse said at least one condition/usage/impact parameter and to initiate an action based on said condition/usage/impact parameter analysis.

15. A remote monitoring station as claimed in claim 14 wherein said processor is adapted to initiate an action comprising generating a condition/usage/impact based recommendation/report based on said condition/usage/impact parameter analysis.

16. A remote monitoring station as claimed in claim 15 wherein the condition/usage/impact based recommendation/report comprises at least one of:
a recommendation to acquire a vehicle of a recommended specification and/or type;
a recommendation to replace a vehicle asset with another vehicle either of the same type or of a different recommended specification and/or type;
a recommendation for vehicle operator training/retraining;
a recommendation for specified vehicle maintenance; and
a recommendation to modify vehicle usage in a specified way.

17. A remote monitoring station as claimed in claim 15 wherein the condition/usage/impact based recommendation/report comprises at least one of:
a maintenance report identifying historic and/or predicted future vehicle maintenance requirements over time;
a cost of ownership report identifying historic and/or estimated future vehicle cost of ownership over time;
an incident report identifying a notifiable incident and a driver responsible; and
a usage report identifying historic and/or predicted future vehicle usage over time.

18. A remote monitoring station as claimed in claim 14 wherein said received operational parameters comprise at least one usage parameter representing geographical usage of the at least one vehicle asset, and wherein said processor is adapted to analyse said at least one geographical usage parameter and to initiate said action based on said geographical usage parameter analysis.

19. A remote monitoring station as claimed in claim 18 wherein the condition/usage/impact based recommendation/report comprises a recommendation to modify vehicle usage in a specified way to optimise at least one of: fleet usage, and movement of the at least one vehicle around a site, whereby to optimise utilisation of said at least one vehicle.

20. A remote monitoring station as claimed in claim 15 wherein said processor is adapted to generate said recommendation/report based further on financial information.
